(19) United States
(12) Patent Application Publication
(10) Pub. No.: US 2026/0212206 A1
(43) Pub. Date: Jul. 23, 2026

(54) METHODS AND APPARATUSES FOR A COLLABORATIVE LEARNING SYSTEM

(71) Applicant: Sony Group Corporation, Tokyo (JP)

(72) Inventors: Thomas CARETTE, Stuttgart (DE); Gonzalo BAILADOR DEL POZO, Stuttgart (DE); Dimitri TORFS, Stuttgart (DE); Olivier ELSHOCHT, Stuttgart (DE); Hugo EMBRECHTS, Stuttgart (DE)

(73) Assignee: Sony Group Corporation, Tokyo (JP)

(21) Appl. No.: 19/136,962

(22) PCT Filed: Sep. 27, 2023
(86) PCT No.: PCT/EP2023/076804

§ 371 Date: Jun. 9, 2025

(30) Foreign Application Priority Data
Dec. 16, 2022 (EP) 22214117.8

(51) Int. Cl. G06N 3/098

(52) U.S. Cl. CPC G06N 3/098

(57) ABSTRACT

The present disclosure relates to a server for a collaborative learning system, communicatively connectable to at least one client device associated with a user. The server comprises a memory configured to store a global generative model adjustable to model a plurality of statistical parameters, and circuitry configured to transmit model information indicating the statistical parameters modeled by the global generative model to the client device. In response, the circuitry receives user-specific authentic statistical information derived from sensor data of the client device. Based on the received information, the server derives a user-specific partial generative model from the global generative model, the partial model being adjusted to generate synthetic sensor data exhibiting statistical properties corresponding to the user-specific authentic statistical information. The server then transmits the user-specific partial generative model to the client device.

### FIELD

The present disclosure generally relates to methods and apparatuses for collaborative learning systems, and more particularly to generative models for secure synthetic data that may be derived from a modular form of a collaborative learning system.

### BACKGROUND

Federated Learning, also known as collaborative learning, is an established machine learning technique that enables the building, expansion, and updating of a centralized machine learning model based on various data samples provided from a client level. Multiple clients may contribute data samples from a respective client device to contribute to the training of a centralized machine learning model. Each client may, in return, obtain access to the centralized machine learning model for personal use.

While federated learning has taken on many different forms, it is still limited by concerns related to privacy and efficiency. Users may wish to keep data samples private but would also benefit from a centralized machine learning model incorporating a large number of other data samples from other clients. Even metadata describing or summarizing data samples of a client may be too sensitive for a user to share.

Another concern is related to the computing speed of such a federated learning system. Most federated learning systems suffer from long computation times, since federated learning systems must process a large pool of data and must also exchange a large amount of data with various clients over numerous iterations.

Beyond a general need for data exchange, there is also a particular need to expand a pool of data that can be used to train a machine learning model for local devices. Such data is difficult to obtain beyond the steady, continual use of a device. Local generative machine learning models may be customized to generate synthetic data that corresponds to authentic user data of the device, but generative machine learning models themselves need to be trained by a large pool of data. The more diverse an existing dataset is, the more expressive and generic synthetic data can be, which may lead to a more effective training of a machine learning model for a local device.

Thus, there is a demand for a collaborative learning system that provides a user with a customized generative machine learning model built on a diverse dataset to generate synthetic data for a local device, while meeting strict privacy and speed requirements.

### SUMMARY

This demand is addressed by apparatuses and methods in accordance with the independent claims. Possibly advantageous embodiments are addressed by the dependent claims.

According to a first aspect, the present disclosure proposes a server for a collaborative learning system. The server is communicatively connectable to at least one client device associated with a user. The server comprises a memory configured to store a global generative model, which is adjustable to model a plurality of statistical parameters. The server further comprises circuitry configured to transmit, to the client device, model information on the plurality of statistical parameters the global generative model is able to model. The circuitry is configured to, in response to the transmitted model information, receive authentic statistical information from the client device. The authentic statistical information corresponds to authentic sensor data of the client device. The circuitry is configured to derive a user-specific partial generative model from the global generative model based on the received authentic statistical information, the user-specific partial generative model being adjusted for generating synthetic sensor data having statistical properties corresponding to the authentic statistical information, and to send the user-specific partial generative model to the client device.

According to a second aspect, the present disclosure proposes a method for a server of a collaborative learning system. The method includes storing a global generative model, which is adjustable to model a plurality of statistical parameters. The method further includes transmitting, to a client device, model information on the plurality of statistical parameters the global generative model is able to model and in response to the transmitted model information, receiving authentic statistical information from the client device, the authentic statistical information corresponding to authentic sensor data of the client device. The method further includes deriving a user-specific partial generative model from the global generative model based on the received authentic statistical information, the user-specific partial generative model being adjusted for generating synthetic sensor data having statistical properties corresponding to the authentic statistical information, and sending the user-specific partial generative model to the client device.

According to a third aspect, the present disclosure proposes a client device for a collaborative learning system. The client device is associated with a user and communicatively connectable to a server. The client device comprises a memory storing authentic sensor data of the user and a circuitry. The client device's circuitry is configured to receive, from the server, model information on a plurality of statistical parameters a global generative model is adjustable to model, and based on the received model information, determine authentic statistical information corresponding to the authentic sensor data. The client device's circuitry is configured to transmit the authentic statistical information to the server, and in response to the transmitted authentic statistical information, receive a user-specific partial generative model from the server. The partial generative model is adjusted for generating synthetic sensor data having statistical properties corresponding to the authentic statistical information.

According to a fourth aspect, the present disclosure proposes a method for a client device of a collaborative learning system. The method includes the client device storing authentic sensor data of the user. The method further includes receiving, from a server, model information on a plurality of statistical parameters a global generative model is able to model, and based on the received model information, determining authentic statistical information corresponding to the authentic sensor data. The method further includes transmitting the authentic statistical information to the server and in response to the transmitted authentic statistical information, receiving a user-specific partial generative model from the server. The partial generative model is adjusted for generating synthetic sensor data having statistical properties corresponding to the authentic statistical information.

According to a fifth aspect, the present disclosure proposes a collaborative learning system comprising a server and at least one client device. The server comprises a server memory storing a global generative model, which is adjustable to model a plurality of statistical parameters, and a server circuitry. The client device is associated with a user, communicatively coupled to the server, and comprises a respective client device memory storing authentic sensor data of the user and a respective client device circuitry. The client device circuitry is configured to receive, from the server, model information on the plurality of statistical parameters the global generative model is able to model and based on the received model information, determine authentic statistical information corresponding to the authentic sensor data and then send the authentic statistical information to the server. The server comprises a server circuitry configured to transmit, to the client device, model information on the plurality of statistical parameters the global generative model is able to model, and in response to the transmitted model information, receive the authentic statistical information from the client device. The server circuitry is configured to derive a user-specific partial generative model from the global generative model based on the received authentic statistical information, the partial generative model being adjusted for generating synthetic sensor data having statistical properties corresponding to the authentic statistical information, and to send the partial generative model to the client device.

### BRIEF DESCRIPTION OF THE FIGURES

Some examples of apparatuses and/or methods will be described in the following by way of example only, and with reference to the accompanying figures, in which

FIG. 1 shows a block diagram of a first embodiment of a collaborative learning system comprising a server, the server comprising a global generative model, and a client device, the client device receiving a partial generative model derived from the global generative model;

FIG. 2 shows a block diagram of a further embodiment of the collaborative learning system further comprising a test to determine which sub-models of the global generative model are selected to derive the partial generative model based on authentic statistical information;

FIG. 3 shows a block diagram of a series of statistical tests to derive the partial generative model from the global generative model;

FIG. 4 shows a block diagram of a further embodiment of the collaborative learning system further comprising an update of the global generative model based on the authentic sensor data;

FIG. 5 shows a block diagram of a further embodiment of the collaborative learning system including model information being sent from the server to the client device, the model information including functions configured to optimize a training of the partial generative model, including a scoping function;

FIG. 6 shows a block diagram of a second series of statistical tests to derive the scoping function;

FIG. 7 shows a block diagram of a further embodiment of the collaborative learning system including a second exchange to generate a calibrated partial generative model;

FIG. 8 shows a block diagram of a further embodiment of the collaborative learning system comprising a separate computing environment that is communicatively connectable to both the server and the client device;

FIG. 9 shows a block diagram of a further embodiment of the collaborative learning system, wherein the server is connected to a first client device and a second client device and derives a user-specific partial generative model from the global generative model for both the first and second client devices;

FIG. 10 shows a block diagram of a procedure to apply a decision model after being trained by synthetic data generated by the partial generative model to calculate a frictionless authentication (FA) score;

FIG. 11 shows a server method for a collaborative learning system according to a first embodiment; and

FIG. 12 shows a client device method for a collaborative learning system according to a first embodiment.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

The Internet of Things (IoT) describes the interconnectedness of physical objects with a processing of sensor data over communication networks. Interconnected sensors and processors may provide a large pool of sensor data to devices that have a need for a diverse dataset, such as devices with machine learning models. The rise of artificial intelligence (AI) has led to many established methods of training machine learning models. With the growth of AI and IoT, we observe a convergence of the fields. More datasets can be generated by a generative model from a central server. Also, more first-line decisions of a decision or discriminative model, which may model a decision boundary using such datasets, are taken directly on device, without relying on a central server. This is desirable both for efficiency and security purposes. Use cases may include instance authentication, anomaly detection, health related alarms, etc.

There are multiple challenges to tackle issues of data availability and model security on a device. The present disclosure proposes an architecture that avoids the sharing of private information related to the decision model. Instead, a proxy generative model is proposed, which allows each client to learn its own decision model locally. By combining concepts related to federated learning between a central server and multiple clients with concepts related to generative machine learning models, a client may obtain a customized generative machine learning model from a central server for personal use while maintaining strict privacy and speed requirements. The skilled person having benefit from the present disclosure will appreciate that the expression “model” may be understood as “machine learning model”.

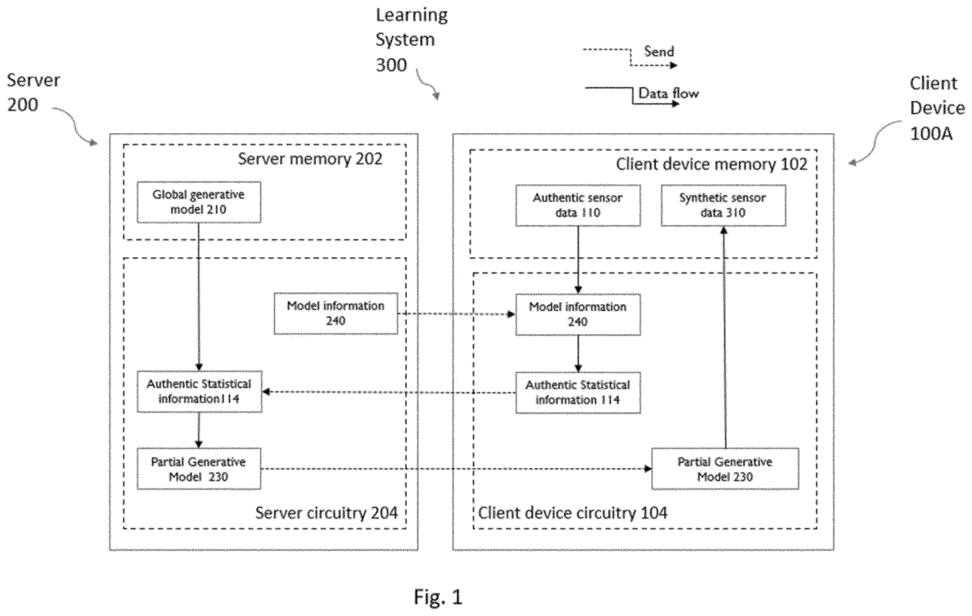

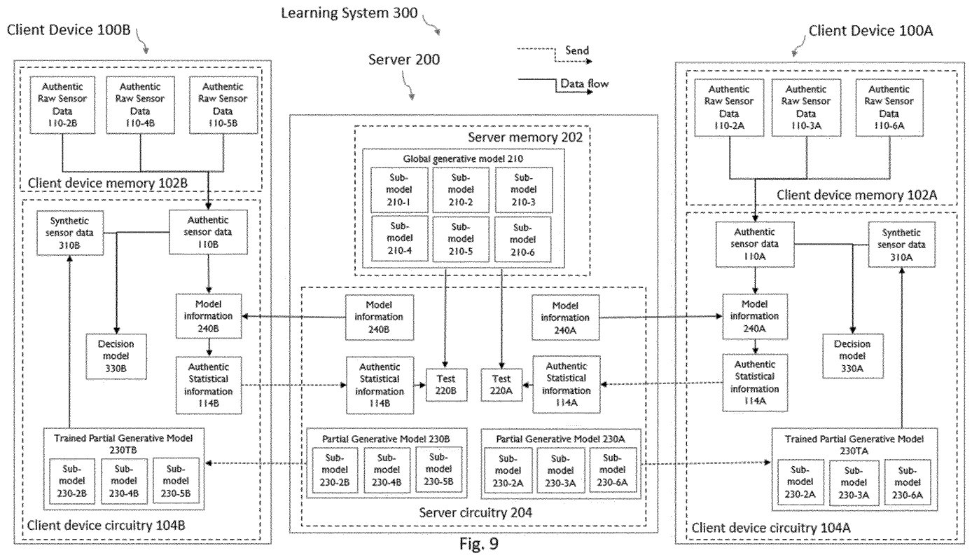

FIG. 1 shows a block diagram of a first embodiment of a collaborative learning system 300 based on the present disclosure. The collaborative learning system 300 comprises a server 200 and at least one client device 100A, associated with a user A. The collaborative learning system 300 may be any system of data or information exchange that includes the server 200 and at least one client device 100A, wherein the client device 100A is communicatively connected to the server 200 and data and information may be exchanged from the server 200 to the client device 100A and vice versa. Descriptions corresponding to the user A and the client device 100A are written without a corresponding “A” unless discussed in comparison to a second user B and a second client device 100B, which appear in the description of FIG. 9. The skilled person having benefit from the present disclosure will appreciate that the collaborative learning system 300 may comprise a plurality of client devices associated with different respective users.

The client device 100A may be any device that is communicatively connectable to the server 200 and has means for a processing and storage of data associated with a user. The client device 100A may comprise a computing device of any form, including a desktop computer, laptop, smartphone, smartwatch, or a computer built as part of an apparatus or vehicle. The client device 100A may be a mobile phone or another portable object, such as a tablet or wristwatch. Descriptions of the client device 100A may apply to any other client device that is communicatively connectable to the server 200. The client device 100A may be associated with a client or user A or it may be associated with a group of clients or users A. The client device 100A comprises a respective client device memory 102 storing authentic (or real) sensor data 110 of the user A.

The authentic sensor data 110 may be any data obtained from a measurement by one or more sensors connected to the first client device 100A. Such measurements may be related to a physical characteristic of an object related to the user A, which may lead to a capturing of physical data by a sensor. One example of a sensor that may capture physical data is an accelerometer. The accelerometer may measure acceleration relative to an inertial reference frame through a force detection mechanism. It may capture information of a change in velocity along an axis of the reference frame. Another example of a sensor that may capture physical data is a gyroscope, which may capture information related to an angular orientation and rotation or rotational velocity of the sensor. Sensors may also provide physical data related to radiation, position, temperature, motion, humidity, pressure, force, current, voltage, contact, and vibration, among other variables. Further types of sensors that may record physical data may include photonic sensors, flow sensors, thermometers, barometers, voltage meters, image sensors, contact sensors, and gas detectors, among others. Such sensors may record data related to physical phenomena that may relate to biometric or behavioral data of the user A.

For example, the authentic sensor data 110 may also take the form of biometric data. Biometric data may include any measurements by a sensor that may relate to bodily functions of the user A. This may include data related to a heart rate of the user. For example, an optical heart rate of the user A may be recorded by a wristwatch equipped with an LED on its inner side that flashes hundreds of times per second, as well as light-sensitive photodiodes to detect volume changes in capillaries above a user's wrist. The wristwatch may record physical data in the form of light data, which may then be processed to calculate biometric data in the form of an optical heart rate. The heart rate of the user may also be measured by an electrocardiogram (ECG). An ECG may record physical data in the form of an electrical current generated by the heart's depolarization and repolarization with electrodes placed on the skin near the heart. Further examples of biometric data may relate to face recognition, fingerprint recognition, voice recognition, and iris recognition, among others.

Physical data and biometric data may be further processed to form behavioral data related to a user, which may be another form of the authentic sensor data 110. For example, biometric data recording a user's heart rate may be further processed, based on classifying different clusters of data with different heart rates, into data describing behavioral patterns, which may include exercise patterns and sleep patterns. Behavioral data may also be recorded without a connection to physical or biometric data. For example, behavioral data may be related to user-based decisions, including data related to a choice of software used, time spent using a software, or user likes on a social media network. The authentic sensor data 110 may take any form of physical data, biometric data, and/or behavioral data. The authentic sensor data 110 may be associated with the user A, or more particularly with a vehicle, laptop, mobile phone, wristwatch, or any other device that may be often and/or exclusively used by the user A. Any sensor configured to collect data associated with the user A can be physically located in the vicinity of the user A or on other devices far away from the user A, and the results of a measurement of the sensor may be centralized on a main device associated with the user A using standard secure communication. From the client device 100A, the authentic sensor data 110 may be summarized into user-specific authentic statistical information 114 to contribute to the collaborative learning system 300. For this, it is configured to send the authentic statistical information 114 to the server 200.

The server 200 may be any piece of computer hardware or software that provides functionality for other programs or devices, including the client device 100A. The server 200 is communicatively connectable to one or more client devices. The server 200 may serve multiple other users, for instance user B and user C, and corresponding client devices 100B and 100C, etc. The server comprises a server memory 202. The server memory 202 may be configured to store data and resources related to data, such as machine learning models. The server 200 comprises a server circuitry 204. The server circuitry 204 may provide various functionalities, such as sharing data or resources from multiple clients with other multiple clients, or performing computation for multiple clients, including the client device 100A.

The server memory 202 is configured to store a global generative model 210. The global generative model 210 is adjustable to model a plurality of statistical parameters related to respective authentic sensor data 110 from different client devices. The server 200 may perform an exchange of data and/or information with multiple client devices, which may enable the global generative model 210 to be updated based on statistical information 114 corresponding to authentic sensor data 110 of each of the client devices. The global generative model 210 may be a global model in the sense that it may be updated according to various contributions of statistical information 114 from various client devices that it has connected with on one or more occasions to perform an exchange of data and/or information.

The global generative model 210 is adjustable to model a plurality of statistical parameters. A statistical parameter is a configurable variable whose value can be estimated from data. In other words, a statistical parameter is a quantifiable characteristic of a dataset (e.g. average, standard deviation), which may be quantified when the statistical parameter is assigned thereto a corresponding value. The statistical parameters of the global generative model 210 may each be a configurable variable that may be assigned a corresponding value. The corresponding value may be adjustable based on the incorporation of new datasets, for example, provided from one or more client devices. A statistical parameter may be associated with a statistical property when it is assigned a corresponding value. An update to the global generative model 210 may include a re-calculation of one or more statistical properties, wherein one or more statistical parameters may have a corresponding value re-calculated based on a contribution of data and/or information from one of the multiple client devices.

A statistical property may comprise a statistical parameter and a corresponding parameter value. For example, a statistical parameter may be a parameter describing an average μ taken over multiple data points and comprising a corresponding average value x. Once the statistical parameter μ is assigned the value x, a statistical property, μ=x, may be established. A statistical parameter may also describe a standard deviation σ taken over multiple data points with a corresponding standard deviation value y. This may establish a statistical property, σ=y. The aforementioned definition of a statistical property may be applied to any form of data/dataset of the client device, server, or further computing apparatuses/devices. A collection of statistical properties may summarize characteristics of interest of a dataset, or a collection of data points, of a specific variable recorded over a chosen time period. An average of the data points for one time period may be calculated after datapoints have been recorded during multiple time periods.

The global generative model 210 may be a generative model because it may comprise the data and information necessary to derive a partial generative model 230 that is configured to generate synthetic sensor data 310. The synthetic sensor data 310 may correspond to the authentic sensor data 110, and thus may thus be useful to the user A. To provide each user with greater privacy, the partial generative model 230 may be sent to each client device from the server 200 for the synthetic sensor data 310 to be generated locally on the respective client device 100A. This is made possible by an exchange of model information 240 related to the global generative model 210 and authentic statistical information 114 related to the authentic sensor data 110 of the user.

The server circuitry 204 is configured to send to the client device 100A model information 240 on the plurality of statistical parameters the global generative model 210 is able to model. The model information 240 may be provided to enable the client device 100A to calculate the authentic statistical information 114 in a form that is relevant to the global generative model 210. More specifically, the model information 240 may comprise instructions for the client device 100A to apply the authentic sensor data 110 in performing calculations of values according to the statistical parameters that the global generative model 210 is able to model. The model information 240 may further include a description of one or more statistical parameters and/or a specific context of the characteristics that the statistical parameter may quantify when a corresponding value is assigned thereto. The description or context may include but is not limited to a specific type of datatype, a specific type of sensor and/or a specific time period. The model information 240 may or may not include corresponding values to the statistical parameters.

In a particular example, a smartwatch equipped with an accelerometer may record the number of steps a user takes per day. Each step may be a datapoint, with a day being the chosen time period. An average and standard deviation may be calculated for the number of steps taken per day recorded over the span of two months. For example, the model information 240 may specify that the global generative model 210 may accept the average (and standard deviation) of the number of steps taken per day by a user. The model information 240 may also specify that the time span of measurement must be at least one month for data reliability. Thus, the values calculated from measurements taken over the span of two months may be sent in the form of statistical information 114. Alternatively, the model information 240 may require other forms of averages. This may be with a different minimal time span or may require specific conditions during the measurement, such as a minimal heart rate to measure steps while running, among other examples. The average and standard deviation may be statistical parameters that provide useful statistical information when assigned to corresponding values. In this example, the values of the statistical parameters may summarize the amount of walking and overall movement of the user over the span of two months. While the authentic sensor data 110 may include each step taken during each day, the values of the average and standard deviation of the number of steps per day may be statistical properties of the authentic sensor data 110 that may be more efficiently shared in the form of statistical information 114.

The client device 100A comprises a respective client device circuitry 104 configured to receive the model information 240 from the server 200. Based on the received model information 240, the client device circuitry 104 is configured to determine the user-specific authentic statistical information 114 based on the user-specific authentic sensor data 110 and send the user-specific authentic statistical information 114 to the server 200. The authentic statistical information 114 may include statistical properties summarizing characteristics or features of interest of the authentic sensor data 110. The authentic statistical information 114 may include a vector of values. Each value may correspond to a statistical parameter, each of which may correspond to one or more statistical parameters of the global generative model 210. For example, an average μ1 of the number of steps taken by a user per day in the authentic statistical information 114 may correspond to an average μ2 that summarizes the same type of data and also incorporating multiple other users that have participated in the collaborative learning system 300. The averages μ1 and μ2 may each be averages based on datasets that have been generated according to the same measurement requirements as specified in the model information 240. The statistical information 114 may further include a description of the specific context for the vector of values, which may include but is not limited to a specific type of datatype, sensor type, and/or time period of data measurement.

The results of the calculations may be sent to the server 200 as part of the authentic statistical information 114. The server circuitry 204 is configured to receive the user-specific authentic statistical information 114 from the client device 100A and derive the user-specific partial generative model 230 from the global generative model 210 based on the received user-specific authentic statistical information 114. The server circuitry 204 is further configured to send the user-specific partial generative model 230 to the client device 100A. The partial generative model 230 is derived after an exchange of the model information 240 and the authentic statistical information 114 and is thus indirectly based on the respective authentic sensor data 110.

The user-specific partial generative model 230 is adjusted for generating user-specific synthetic (or artificial) sensor data 310 having statistical properties corresponding to the user-specific authentic statistical information 114, and thus corresponding to the user-specific authentic sensor data 110. In other words, the statistical properties of the user-specific authentic sensor data 114 may be similar, or in some cases even indistinguishable, from the statistical properties of the user-specific synthetic sensor data 310. The synthetic sensor data 310 may be stored in the client device memory 102 (as shown in FIG. 1) for later use or it may be directly applied in a training of a machine learning model that may be located on the client device 100A. The user-specific partial generative model 230 may thus expand the pool of data available for training a machine learning model located on the client device 100A. Such a machine learning model may require a larger pool of data for a desired training, which may necessitate the client device 100A to receive the user-specific partial generative model 230 from the server 200. The synthetic sensor data 310 may also be used for other various applications in the client device of the user or in other devices.

The client device 100A may be configured to accumulate various forms of authentic (or real) sensor data 110 to be stored in the client device memory 102. The authentic sensor data 110 may be labeled as authentic since it may correspond to an application of one or more sensors by a real-world user. More specifically, it may describe a gradual, steady use of one or more sensors that accurately reflects real-world behavior of the real-world user. In comparison, synthetic sensor data 310 may be labeled as synthetic since it may have been generated by a generative model, particularly the partial generative model 230, and may thus have been artificially made, or synthesized, particularly based on the authentic sensor data 110. The authentic sensor data 110 and synthetic sensor data 310 may comprise similar, or in some cases even indistinguishable, statistical properties. As such, the synthetic sensor data 310 may enable a training of the decision model that reflects a training dataset based on the authentic sensor data 110 and that otherwise may not be possible, with the authentic sensor data 110 alone comprising too small of a training dataset.

The partial generative model 230 may be partial because it may comprise a subset of data and/or information that the global generative model 210 comprises. The authentic sensor data 110 of each client device may comprise data that corresponds to a restricted range of data types, which may correspond to specific types of physical, biometric, and/or behavioral data and/or specific organizational forms of data. The data types of the respective client device may be restricted according to a collection of sensors available to the respective user and/or a specific configuration of the respective client device. The partial generative model 230 may be user-specific in the sense that it may be restricted to comprising portions of the global generative model 210 that may be relevant to the data types corresponding to the authentic sensor data 110. For example, the partial generative model 230 may comprise a subset of statistical parameters of the plurality of statistical parameters that are modelled by the global generative model 210. Statistical properties related to the statistical parameters of the partial generative model 230 may be fixed or adjustable. The partial generative model 230 may initially be fixed based on most recently updated values of each statistical parameter of the global generative model 210 and sent with an initially fixed configuration. The partial generative model 230 may be adjustable if it is provided a training by the authentic sensor data 110 on the client device 100A.

In a further embodiment, the global generative model 210 may be of a modular form comprising a plurality of sub-models and the model information 240 may comprise information that may enable the client device 100A to determine which portions of the global generative model 210 may be relevant to the authentic sensor data 110. The model information 240 may thus be used to determine a subset of the plurality of sub-models to be applied in deriving the partial generative model 230.

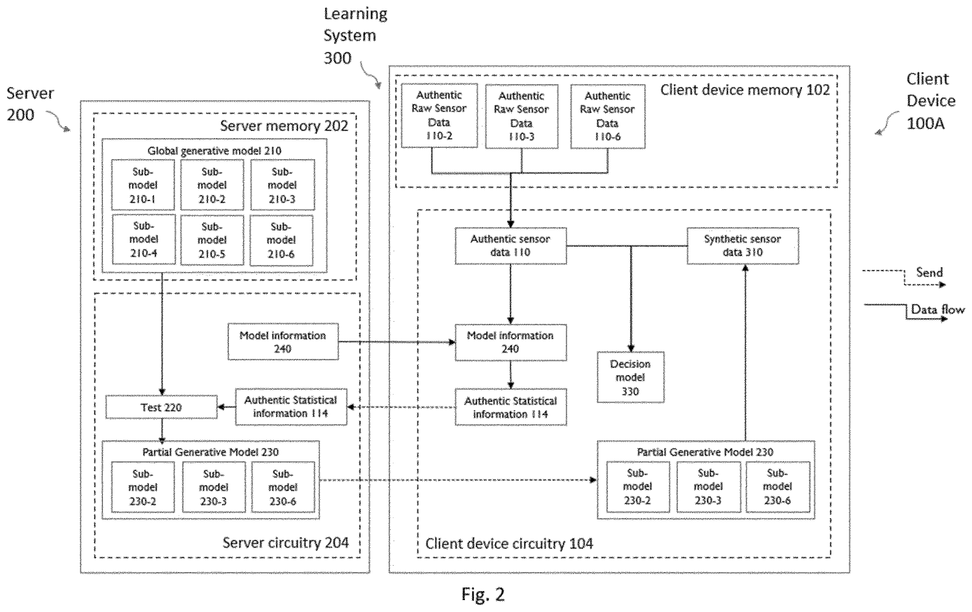

FIG. 2 shows a block diagram of a further embodiment of the collaborative learning system 300 based on the present disclosure. The global generative model 210 may have a modular form, comprising a plurality of global generative sub-models 210-1 to 210-6. Each sub-model may be adjustable to model a different subset of the plurality of statistical parameters that the global generative model 210 is able to model. The authentic statistical information 114 may comprise statistical properties that are related to only a subset of the plurality of statistical parameters that the global generative model 210 is able to model. For example, a statistical parameter, average μ3, which may describe a specific type of calculation under a specific context, may be assigned a value z, forming a statistical property μ3=z. This statistical property may correspond to a statistical parameter within the sub-model 210-3 that is based on the same specific type of calculation under the same specific context, which may be outlined in the model information 240. Also, it may be that μ3 does not correspond to the sub-model 210-4 since sub-model 210-4 does not comprise any statistical parameters of the same type of calculation and/or under the same context. In other words, the statistical parameter μ3 and any statistical property related to μ3, such as μ3=z, may only relate to and be relevant to sub-model 210-3 and may only contribute to the global generative model 210 through the sub-model 210-3. In this sense, the authentic statistical information 114 may comprise multiple statistical properties, which may collectively relate to a subset of the plurality of statistical parameters that the global generative model 210 is able to model.

In a modular form, a greater efficiency of data exchange may be achieved by forming the partial generative model 230 with only a subset of the totality of the sub-models 210-1 to 210-6 that are relevant to the user A, and thus only sending a relevant portion of the global generative model 210 as the user-specific partial generative model 230 to the client device 100A. Once sent, the user-specific partial generative model 230 may then be used to generate synthetic sensor data 310 that is relevant to the training of a decision model 330 located on the client device 100A and also may be prevented from generating data that may not be relevant to the user A. By forming the partial generative model 230 in such a customized form, an even wider variety of users may benefit from the global generative model 210 that would otherwise find the entire global generative model too large and too cumbersome to process or filter. This feature may also enable the server 200 to perform such an exchange with many other users without the collaborative learning system 300 becoming overwhelmed by large data processing requirements.

The global generative model 210 may be a discrete model. In a discrete global model, the statistical parameters to be modelled may comprise discrete vectors with a countable set of values. The values in a discrete vector may be restricted in their domain, such as an integral domain or a domain with a fixed number of decimal points. As such, the global generative sub-models and/or partial generative sub-models may be formed in a discrete fashion. The global generative model 210 may be a continuous model. In a continuous global model, the statistical parameters to be modelled may comprise continuous datasets, such as continuous vectors. Continuous vectors may comprise values within a continuous domain. For example, a continuous domain may simply require each value to be a real number without fixed limitations to decimal points or precision. A continuous global model may also have an infinite number of possible sub-model combinations. For example, a sub-model may be derived based on an inclusion of datapoints within an interval. If the interval is continuous, the inclusion of datapoints may be performed based on a restriction of the interval between any two real numbers. As such, the global generative sub-models and/or partial generative sub-models may be formed in a continuous fashion.

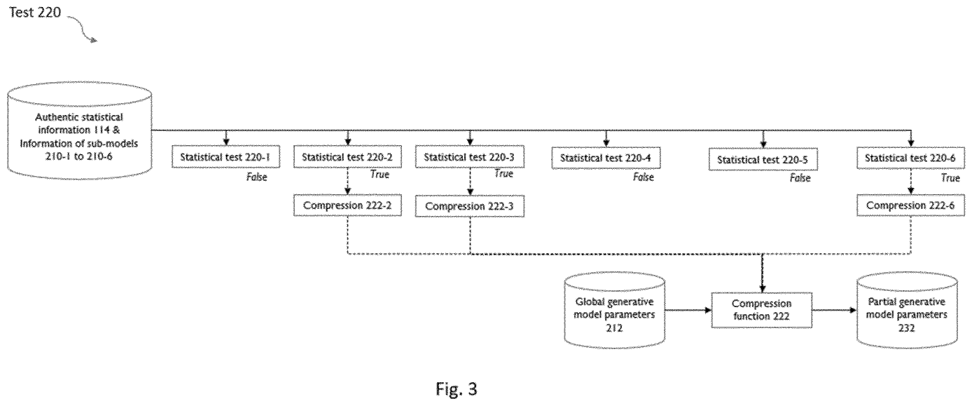

The sub-models 210-1 to 210-6 may each undergo a test 220 (further discussed in FIG. 3) to test whether the particular sub-model is relevant to the authentic statistical information 114. The test 220 may determine that one or more sub-models 210-1 to 210-6 are relevant to the authentic statistical information 114, and thus to the authentic sensor data 110, and may derive the partial generative model from the selected sub-models. The server circuitry 204 may be configured to add a most recently updated version of each global generative sub-model 210-1 to 210-6 to the partial generative model 230. Each updated version of a global generative sub-model may comprise one or more updates that may correspond to a previous data exchange between another client device and the server 200. For example, in FIG. 2, the global generative sub-models 210-2, 210-3 and 210-6 are shown to have been selected based on the test 220 to derive the partial generative model 230. The partial generative sub-models 230-2, 230-3, and 230-6 that form the partial generative model 230 may thus each be equivalent to the most recently updated version of their corresponding global generative sub-model, 210-2, 210-3, and 210-6, respectively.

The model information 240 may comprise information that the client device 100A may apply to calculate the authentic statistical information 114 in a useful form for the global generative model 210. For example, the model information 240 may include instructions for the client device 100A to calculate the authentic statistical information 114 in a way that leads to a determination of a subset, or scope, of sub-models. In response to the model information 240, the authentic statistical information 114 sent to the server may include explicit instructions of selecting certain sub-models of the global generative model 210 when forming the partial generative model 230 during the test 220. The server 200 may also be configured to receive a list comprising an explicitly specified scope of sub-models from the client device 100A to be applied during the test 220. Such a procedure may be referred to as explicit scoping.

In some cases, the authentic sensor data 110 may be limited so that after receiving model information 240, no sub-model may be clearly determined as relevant in forming the partial generative model 230. In an alternative embodiment, if the above explicit scoping method to derive the partial generative model 230 is not adequate, then another more implicit method of selecting a subset, or scope, of sub-models may be used. The server 200 may send instructions for such an implicit scoping method as part of the model information 240 or it may be sent separately if the client device 100A informs the server 200 that all other methods have failed.

An extra collection of authentic sensor data 110 may optionally be collected according to extra instructions from the server 200, which may provide data samples to the client device 100A in a form that can better relate to the global generative model 210. The server 200 may send with the extra instructions a set of statistical parameters related to the authentic sensor data 110 to have their corresponding values computed, optionally sent with accuracy requirements. The client device 100A may compute the values, may optionally apply a perturbation to further protect their privacy, and then send the results as part of the authentic statistical information 114 to the server 200. The server 200 may then apply one or more statistical tests to the authentic statistical information 114 to implicitly determine the scope of sub-models, use it to derive the partial generative model 230 from the global generative model 210, and then send the partial generative model 230 to the client device 100A. Such explicit and implicit scoping methods are not mutually exclusive and may be performed in combination. For example, sub-models chosen by an explicit scoping method may also undergo one or more statistical tests as part of an implicit scoping method.

Such a modular form of the global generative model 210 may be particularly useful if the client device 100A has stored in the client device memory 102 various forms of raw sensor data, such as authentic raw sensor data 110-2, 110-3, and 110-6 in client device 100A in FIG. 2. For example, the authentic raw sensor data 110-2;110-3;110-6 may be physical data corresponding to a measurement that may correspond to a respective sub-model of the global generative model 210. A processing of the authentic raw sensor data 110-2;110-3;110-6 into authentic sensor data 110 and/or into the authentic statistical information 114 may be customized based on the model information 240 to provide it with a context or meaning in a particular way so that it may be modelled by a particular sub-model of the global generative model 210. The modular form of the global generative model may decrease the processing requirements of both the server circuitry 204 and the client device 100A and may thus enable the collaborative learning system 300 to include a larger number of users. This, in turn, may enable each user to benefit from a more diverse pool of data that may benefit a training of the respective local decision model 330 even more.

For example, the global generative model 210 may be a clustering model. Clustering is an exploratory data analysis technique that may be used to organize data more efficiently. It may include identifying subgroups, or clusters, among a collection of data points, such that the data points in the same cluster are similar regarding a chosen similarity measure or variable. The clustering model may be a Gaussian mixture model, which may comprise multiple clusters, each cluster comprising its own Gaussian distribution of one or more dimensions. Gaussian mixture models may be particularly useful for modelling datasets comprising a large number of dimensions. The Gaussian distribution is a probability density function with the general form:

$$f ( x ) = \frac{1}{σ \sqrt{2 π}} {e}^{- \frac{1}{2} {( \frac{x - μ}{σ} )}^{2}}$$

The parameter μ is the mean of the distribution, which may convey a central location of a collection of datapoints, or a centroid, and the parameter σ is the standard deviation, which may convey how broadly distributed the collection of datapoints is in reference to the centroid. Each sub-model in the global generative model 210 may comprise one or more Gaussian distributions of datapoints. A Gaussian mixture model may comprise K components, or clusters, each with D dimensions related to its centroid, and may thus comprise K times D centroid parameters. The Gaussian mixture model may comprise K*(D−1)*(D/2) covariance parameters describing a standard deviation of a centroid.

A Gaussian mixture model may perform an expectation maximization (EM) algorithm to classify datapoints to one or more sub-models based on a calculated probability of belonging to a sub-model. The categorization may be performed applying a nearest neighbor logic that uses distance calculations, such as a Euclidean distance or a Mahalanobis distance. While the Euclidean distance may be optimal for a univariate case, the Mahalanobis distance may often be more appropriate for a multivariate case, particularly, in cases where one or more variables may receive a greater weight within the model.

A Gaussian mixture model form of the global generative model 210 may enable an effective use of the previously outlined implicit scoping methods, which may enable efficient data exchange while maintaining a high level of privacy for the user A. For example, the model information 240 may include information related to centroids of the global generative model 210 in the form of vectors, which may be sent to the client device 100A. The client device 100A may perform calculations on the centroids according to the model information 240 or extra instructions relating the authentic sensor data 110 by applying a nearest neighbor logic, which may use Euclidean or Mahalanobis distance calculations, and then send the results to the server 200. Another option may be to apply nearest neighbor logic using cryptographic means, such as with multi-party computation (MPC) or homomorphic encryption. A custom algorithm may also be used. The server 200 may send an appropriate subset of datapoints corresponding to each centroid to reduce the amount of data exchange and processing required by the client device 100A, while still enabling efficient categorization of the authentic sensor data 110 to the centroids.

FIG. 3 shows a block diagram of a series of statistical tests 220-1 to 220-6 that may be included in test 220. The test 220 may be in the form as shown in FIG. 3, configured to receive as an input the authentic statistical information 114 and information related to the complete set of sub-models 210-1 to 210-6 of the global generative model 210 and to generate as an output a compression function 222, which may be applied in the derivation of the partial generative model 230 from the global generative model 210. The statistical tests 220-1 to 220-6 may correspond to the global generative sub-models 210-1 to 210-6, respectively. Each of the statistical tests 220-1 to 220-6 may lead to a Boolean with a value of True or False. A statistical test producing a Boolean of True may eventually lead to an inclusion of the corresponding global generative sub-model in the partial generative model 230, while producing a Boolean of False may lead to an exclusion therefrom.

In one particular example of the global generative model 210, the statistical test 220-1 may test for whether at least 1% of the total number of datapoints of the authentic sensor data 110 belongs to a particular sub-model 210-1. If this is the case, the statistical test may lead to a Boolean value of True and the server circuitry 204 may be configured to include the sub-model 210-1 in the derivation of the partial generative model 230 based on the True Boolean. For example, the statistical tests 220-1 to 220-6 may each perform a test whether at least 1% of datapoints of the authentic sensor data 110 correspond to the sub-model 210-1 to 210-6, respectively. In each case, if the respective statistical test leads to a Boolean value of True, the server circuitry 204 may be configured to generate a compression 222-2; 222-3; 222-6 corresponding to the sub-model to be incorporated in a compression function 222. For example in FIG. 2, statistical tests 220-2, 220-3, and 220-6 may have led to a Boolean of True, leading to the generation of compressions 222-2, 222-3, and 222-6 that may be included in the compression function 222. The compression 222, when applied, may then include global generative sub-models 210-2, 210-3, and 210-6 in the derivation of the partial generative model 230. On the other hand, statistical tests 220-1, 220-4, and 220-5 may have led to a Boolean of False, thereby not leading to any inclusion of the respective sub-models into the compression function 222. The statistical tests 220-1 to 220-6 may be independent of each other and may be applied in any order.

The server circuitry 204 may be configured to, based on the test 220, generate a compression function 222 based on all compressions 222-2; 222-3; 222-6 corresponding to a statistical test leading to a True Boolean. The compression function 224 may be configured to receive as an input a full set of statistical parameters of the global generative model 210, global generative model parameters 212, and generate as an output a subset of the full set of statistical parameters of the global generative model 210 to be included in deriving the partial generative model 230, partial generative model parameters 232. The included statistical parameters may have corresponding thereto a most recently updated value within the global generative model 210 to be included in the partial generative model 230, which may then be sent to the client device 100A.

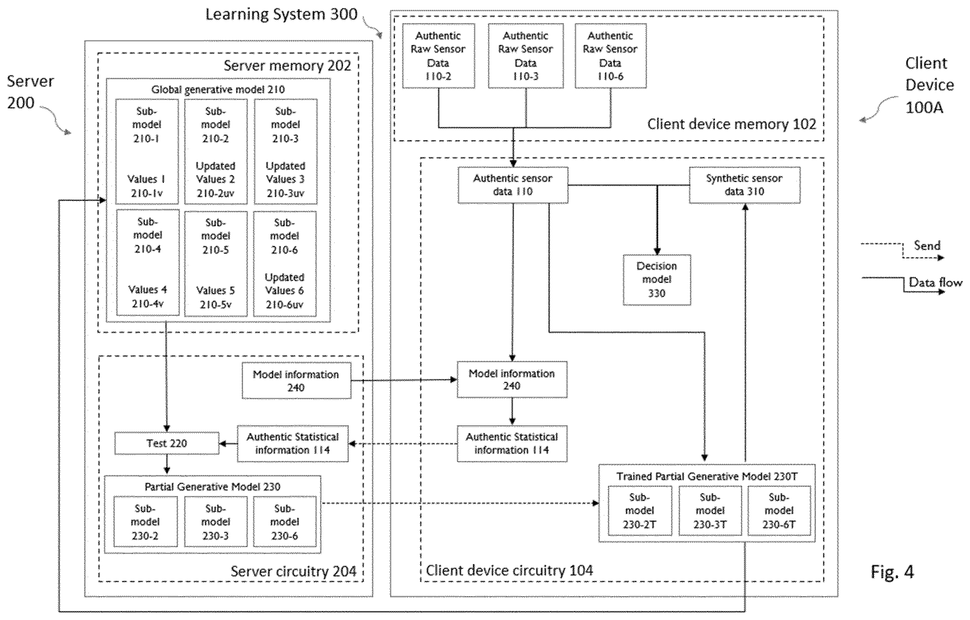

FIG. 4 shows a block diagram of a further embodiment of the collaborative learning system 300 based on the present disclosure. The server circuitry 204 may be configured to update the one or more global generative sub-models 210-1 to 210-6 of the global generative model that were selected to derive the first user-specific partial generative model 230 based on the first authentic statistical information 114, wherein global generative sub-models 210-1 to 210-6 of the global generative model 210 that were not selected to derive the first user-specific partial generative model 230 remain independent of the first authentic sensor data 110. The global generative model 210 may be in modular form that makes such a partial update possible. For example, since only the sub-models 210-2, 210-3, and 210-6 were chosen as relevant to the authentic statistical information 114, only these sub-models need to be updated based thereon. The server circuitry 204 may be configured to only update the sub-models that are relevant to the user-specific authentic statistical information 114 as part of a modular global generative model 210, decreasing the processing requirements and enabling a larger scale of users to participate in the collaborative learning system 300 and with a greater speed of data exchange.

The authentic statistical information 114 may include information or metadata summarizing statistical properties of interest of the authentic sensor data 110 that may be shared directly with the server 200. The client device 100A may be configured to alert the user of what information would be shared and allow the user to customize what information to share as part of the authentic statistical information 114. The authentic statistical information 114 may offer relevant information regarding particular global generative sub-models and may thus directly contribute to them in the form of an update. Such an update may be another means of how the global generative model 210 accumulates its large pool of data that each user may benefit from for the training of its own model locally.

The collaborative learning system 300 may also be designed to limit the sharing of information between multiple users by sharing information indirectly in the form of a trained sub-model. For example, instead of sharing the authentic sensor data 110 or even summarized metadata related to the authentic sensor data 110, the partial generative model 230 received by the first client device 100A may be trained locally, using the authentic sensor data 110 as additional training data, to become a trained partial generative model 230T. The trained partial generative model 230T may then be used to update the global generative model 210 in an indirect form. Each sub-model sent to the client device 100A as part of the partial generative model 230 may become trained sub-models 230-2T, 230-3T, and 230-6T as part of the trained partial generative model 230T. Once given sufficient training from the authentic sensor data 110, these trained sub-models may be ready to be sent to the server 200 and to be incorporated into the corresponding global generative sub-models 210-2, 210-3, and 210-6. The server 200 may comprise an update algorithm configured to receive partial generative sub-models trained by the client device 100A and to incorporate the trained partial generative sub-models into the corresponding global generative sub-models. The trained sub-models of the trained partial generative model 230T may also generate synthetic sensor data 310 with statistical properties corresponding to the authentic sensor data 110, which may expand a pool of data available to the local decision model 330 to be trained locally. Since both the authentic sensor data 110 and synthetic sensor data 310 may remain restricted to the client device 100A, a high standard of privacy may be maintained. The authentic statistical information 114 may be restricted to only revealing the scope of sub-models to be applied in the test 220, since the global generative model 210 may receive an update from the first client device in the form of its trained partial generative model 230T. Such an embodiment may also allow the client device to perform the data exchange and generation of synthetic sensor data 310 more efficiently, since both are achieved by means of the trained partial generative model 230T.

As shown in FIG. 4, each global generative sub-model 210-1 to 210-6 may also comprise one or more corresponding values. Each sub-model may also be adjustable so that each corresponding value may be a most recently updated value. The global generative model 210 may be configured so that after an update, either indirectly by the trained partial generative model 230T or directly by the authentic statistical information 114, only the sub-models chosen by the test 220 may comprise newly updated values. For example in FIG. 4, while sub-models 210-1, 210-4, and 210-5 that were not chosen to derive the partial generative model 230 are shown to still comprise their original values as 210-1v, 210-4v, and 210-5v after the update, the sub-models that were chosen to derive the partial generative model 230 are shown to comprise updated values as 210-2uv, 210-3uv, and 210-6uv.

The global generative model 210 may be a neural network and may be updated based on a specific configuration used to receive the authentic statistical information 114 and to derive the partial generative model 230. In a particular example, the global generative model may comprise one or more attention layers, which may receive the authentic statistical information 114 as input. The one or more attention layers may label certain portions of input data to be processed in a specific manner. For example, in an encoder-decoder architecture, particularly when input data of different lengths and complexities are represented by a fixed-length vector, the decoder may potentially miss important information. An attention layer with attention weights introducing an attention mechanism may prevent this. For example, certain vectors or certain portions of a vector representing characteristics of greater importance may be attributed to greater weights. In doing so, the decoder may process the input information with a specific focus on characteristics of the input data most relevant for generating output. As such, the partial generative model 230 may be further personalized for the client device 100A through such an attention-like mechanism to generate the synthetic data 310 with similar or indistinguishable statistical properties compared to the authentic sensor data 110.

The attention-like mechanism through which the partial generative model 230 was derived may also enable an update to the global generative model 210 to be efficiently performed based on the trained partial generative model 230T. For example, the update to the global generative model 210 may be provided by a related attention mechanism, which may involve the same attention layer used to accept the authentic statistical information 114 and/or to derive the partial generative model 230. Such an attention layer may be re-learned according to each data and/or information exchange with a respective client device.

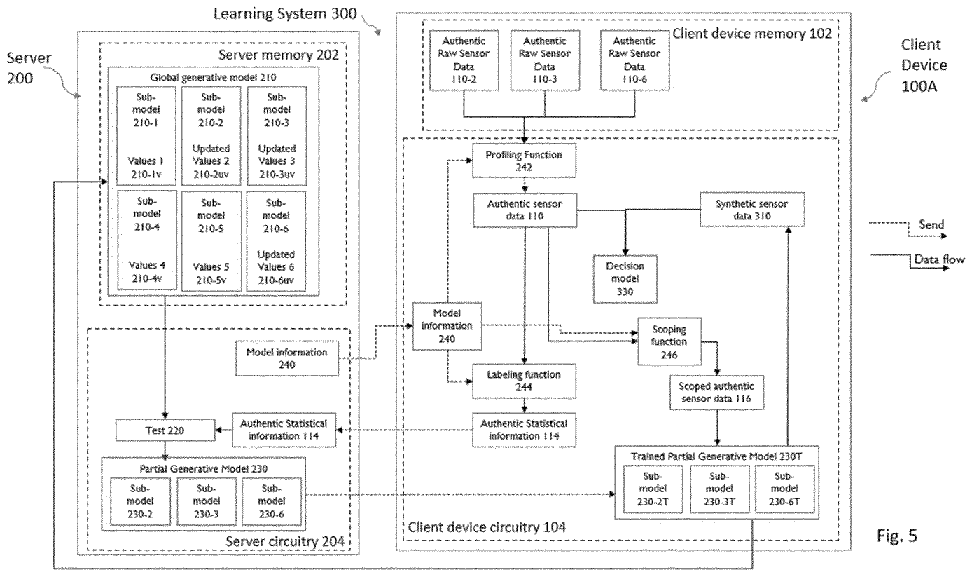

FIG. 5 shows a block diagram of the collaborative learning system 300 including the server 200 and the client device 100A of a further embodiment of the present disclosure. In a further embodiment, the model information 240 may comprise information related to a profiling function 242, a labeling function 244, and/or a scoping function 246.

The profiling function 242 may receive as input the authentic raw sensor data 110-2; 110-3; 110-6 and may generate as output the authentic sensor data 110. The authentic sensor data 110 may be an organized form of the authentic raw sensor data. For example, the authentic raw sensor data 110-2; 110-3; 110-6 may correspond to unprocessed data more related to physical data, or data recorded based on physical phenomena without a context or meaning that describes the data. The authentic sensor data 110 may be biometric and/or behavioral data that may be given such a context or meaning after a processing. The modelling information 240 may include the profiling function 242 to have the authentic raw sensor data processed in a way that may be more compatible with the global generative model 210 to facilitate a more effective sharing of data between the server 200 and the client device 100A. The profiling function 242 may comprise a set of statistical parameters to have one or more corresponding values calculated to obtain a set of statistical properties. The set of statistical parameters may be fixed or they may be learned within the server 200 based on updates from one or more users of the collaborative learning system 300. For example, if further sub-models are formed within the global generative model 210 based on updates from one or more users, the profiling function may be updated, either manually or by an automated process. The profiling function 242 may then comprise an updated set of statistical parameters that the global generative model 210 is able to model. The model information 240 may also comprise information on how to compute values for each statistical parameter, which may be shared with the profiling function 242. The authentic sensor data 110 may then take a form that may be more compatible with the global generative model 210 and may thus be used to train the received partial generative model 230 more effectively.

The model information 240 may further comprise the labeling function 244. The labeling function 244 may be configured to label certain portions of the authentic sensor data 110 that may be used in the test 220 to determine the scope of sub-models. For example, given an input of the authentic sensor data 110 and information related to the global generative model 210, the labeling function 244 may generate as an output a list comprising the scope of sub-models to be selected during the test 220 to derive the partial generative model 230 from the global generative model 210. Such a list may be included in the authentic statistical information 114 to be sent to the server 200.

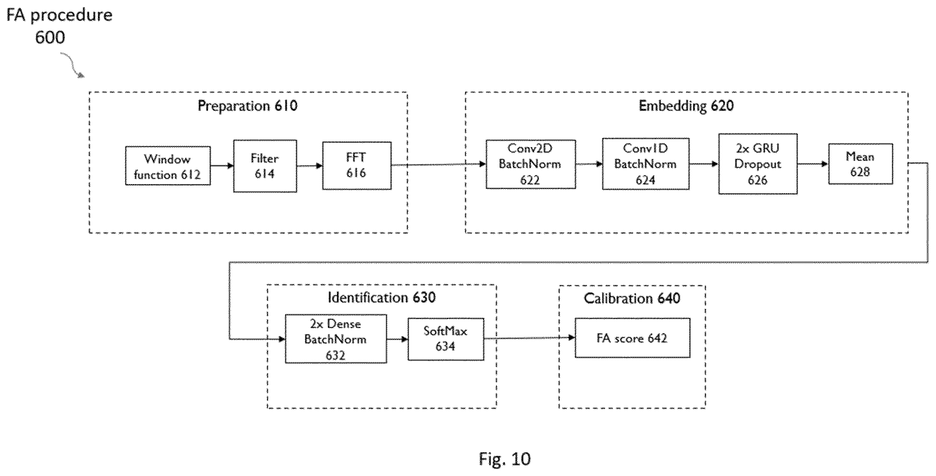

The model information 240 may further comprise the scoping function 246. The scoping function 246 may receive as an input the authentic sensor data 110 and may generate as an output scoped authentic sensor data 116. The scoping function 246 may be applied to ensure that the authentic sensor data 110 is of a precisely constructed form that is optimal to train the received partial generative model 230. The partial generative model 230 may use the scoped authentic sensor data 116 to become the trained partial generative model 230T that may be used to generate the synthetic sensor data 310. The scoping function 246 may thus ensure that the generated synthetic sensor data 310 has statistical properties that are similar, or in some cases even indistinguishable, from the authentic sensor data 110. In other words, the scoping function 246 may ensure that the synthetic sensor data 310 generated by the trained partial generative model 230T is aligned with the authentic sensor data 110, so that the decision model 330 may be coherently trained by both forms of data. This training may then be applied, for example, in a frictionless authentication procedure 600 (described in further detail in FIG. 10). The scoping function 246 may also filter unnecessary or irrelevant data to ensure an effective and more efficient training. For example, the scoping function 246 may take the form of an embedding configured to receive as input the authentic sensor data 110 and generate as output embedded, or scoped, authentic sensor data 116. In the context of machine learning, the embedding may be a low-dimensional, learned continuous vector representation of discrete variables into which one can translate high-dimensional vectors with an embedding neural network.

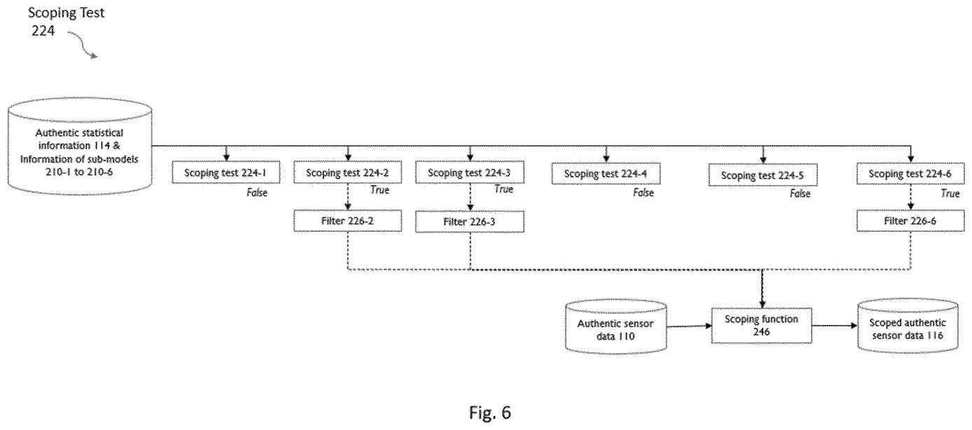

FIG. 6 shows a block diagram of a series of statistical tests, or scoping tests 224-1 to 224-6, that may be applied in a scoping test 224 to form the scoping function 246. Instructions for the client device 100A to execute the scoping test 224 may be included with the model information 240 sent from the server 200 to the client device 100A. The scoping test 224 may receive as an input the authentic statistical information 114 and information related to sub-models 210-1 to 210-6 and may generate as an output a series of filters to include in the scoping function 246. For example, the scoping test 224 may test for each sub-model 210-1 to 210-6 (in an analogous fashion to the test 220) whether at least 1% of the total number of datapoints of the authentic sensor data 110 belongs to the sub-model and if this is the case, generate a Boolean of True. In the case of FIG. 5, the scoping test 224 may obtain a True Boolean for scoping tests 224-2, 224-3, and 224-6, corresponding to global generative sub-models 210-2, 210-3, and 210-6, respectively. The client device circuitry 104 may be configured to generate corresponding filters 226-2, 226-3, and 226-6 and include them in the scoping function 246. Thus, in FIG. 5, the scoping function 246 may include a filter that confines the authentic sensor data 110 to information that is relevant to the global generative sub-models 210-2, 210-3, and 210-6, and thus also to the partial generative sub-models 230-2, 230-3, and 230-6. The scoping function 246 may be applied to the authentic sensor data 110 to generate the scoped authentic sensor data 116 and the partial generative model 230 may then be trained by the scoped authentic sensor data 116. Once trained, the trained partial generative model 230T, which may generate the synthetic sensor data 310 to be used in training the decision model 330. The authentic sensor data 110 and the synthetic sensor data 310 may then coherently train the decision model 330 on the client device 100A.

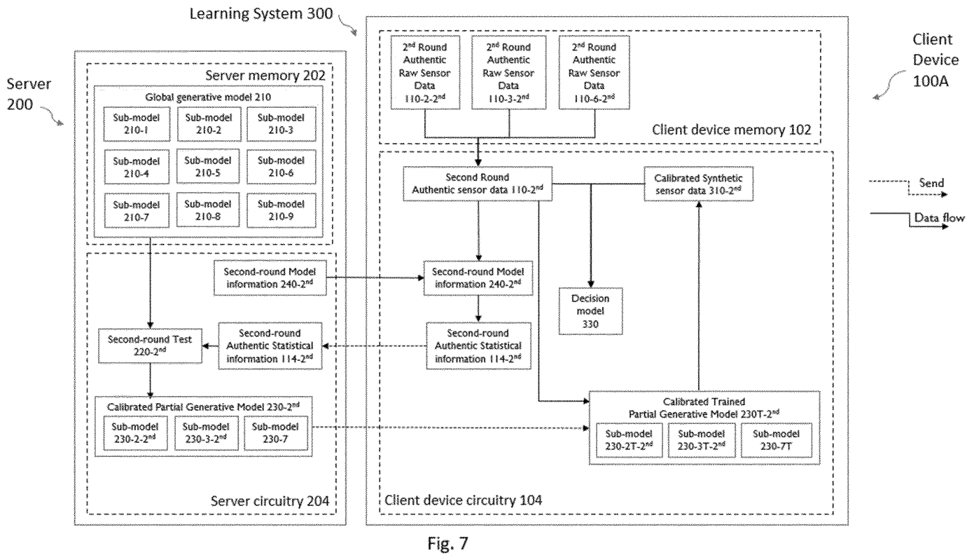

FIG. 7 shows a block diagram of a further embodiment of the collaborative learning system 300 based on the present disclosure emphasizing a 2^{nd} round exchange between the client device 100A and the server 200. The server 200 may be configured to be communicatively connectable to multiple client devices. Thus, the server 200 may carry out multiple data exchanges, as outlined in FIG. 1 and FIG. 2 for client device 100A, with multiple other client devices, each exchange leading to a respective update of the global generative model 210, as outlined in FIG. 4. At a later point in time, the user associated with the client device 100A may have accumulated further authentic sensor data 110-2^{nd}, or in other words, a second round of sensor data 110-2^{nd} from a second measurement iteration by the user A. In this case, a second round of communication between the client device 100A and the server 200 may be initiated to perform a second data exchange, which may then provide a calibrated partial generative model 230-2^{nd} to the client device and a new update to the global generative model 210.

The second round of sensor data 110-2^{nd} may be used to calculate a second-round of authentic statistical information 114-2^{nd}. The server 200 may be configured to transmit second-round model information 240-2^{nd}, or newly updated information on the plurality of statistical parameters the global generative model 210 is able to model. This is particularly useful if the global generative model 210 has expanded to include further sub-models, such as 210-7, 210-8, and 210-9 shown in FIG. 7. The second-round model information 240-2^{nd} may thus include information on sub-models 210-7 to 210-9 in addition to information on sub-models 210-1 to 210-6. The newly formed sub-models 210-7 to 210-9 may include new statistical parameters modelled by the global generative model 210, thus expanding the pool of the plurality of statistical parameters that the global generative model 210 is able to model. Given the second-round model information 240-2^{nd}, the client device 100A may be configured to calculate second-round authentic statistical information 114-2^{nd} to be sent to the server 200.

The server circuitry 204 may be configured to receive second-round authentic statistical information 114-2^{nd} from the client device 100A. Then based on the received second-round authentic statistical information 114-2^{nd}, the server circuitry 204 may be configured to apply a second-round test 220-2^{nd} to at least one or more of the global generative sub-models whether it should be selected to derive a calibrated user-specific partial generative model 230-2^{nd} and then derive the calibrated user-specific partial generative model 230-2^{nd} based on at least one selected global generative sub-model and then send it to the client device 100A. As such, the choice of scope of sub-models can be re-evaluated by the server 200. The second-round model information 240-2^{nd} from the server 200 or the second-round authentic sensor data 110-2^{nd} communicated by the user A may lead the second-round test 220-2^{nd} to select an updated scope of sub-models for the calibrated partial generative model 230-2^{nd} to reflect the second-round measurement iteration of the user A more accurately.

The calibrated partial generative model 230-2^{nd} derived from the global generative model 210 in FIG. 7 includes an updated version of sub-models 210-2 and 210-3, formed as 230-2-2^{nd} and 230-3-2^{nd} in the calibrated partial generative model 230-2^{nd}. In this instance, the calibrated partial generative model 230-2^{nd} may not have included the sub-model 210-6 from the global generative model 210. The server circuitry 204 may be configured to derive the calibrated partial generative model 230-2^{nd} based only on a most recent or second-round statistical test 220-2^{nd}. In a case where the 2^{nd} round test 220-2^{nd} determined the sub-model 210-6 to not be relevant to the authentic statistical information 114-2^{nd}, the sub-model 210-6 may be excluded from the calibrated partial generative model 230-2^{nd}. Thus, the trained calibrated partial generative model 230T-2^{nd} may be configured to generate synthetic data 310-2^{nd} that does not comprise any data corresponding to the sub-model 210-6, since it was determined by the second-round test 220-2^{nd} to not be relevant to the user A.

The calibrated partial generative model 230-2^{nd} also includes 230-7, which was not included in the original partial generative model 230. While sub-model 210-7 may have been previously unavailable and may thus have not been included in the global generative model 210 in the first exchange, it may have become available in the second exchange and information related thereto may have been included in the second-round model information 240-2^{nd}. The authentic statistical information 114-2^{nd} may then include information corresponding to the 2^{nd} round authentic sensor data 110-2^{nd} that is related to sub-model 210-7. It may also be that such information related to 210-7 was included in the original 1^{st} round authentic sensor data 110, corresponding to a first measurement iteration by the user A, but was filtered out by the first-round test 220, since it did not correspond to the plurality of statistical parameters that the global generative model 210 was able to model at that time.

With such a configuration of the collaborative learning system 300, the user A may update the learning of the decision model 330 on the client device 100A with synthetic sensor data 310-2^{nd} that is more adapted to the meet specific requirements of the client device 100A over time. The updated learning of the decision model 330 may be in a form to include synthetic data 310 derived from a newly added sub-model, such as 210-7, and to exclude potential synthetic data that would be derived from a sub-model added in a previous round, such as 210-6, determined to no longer be relevant to the decision model 330.

The server circuitry 204 may be configured to expand the global generative model 210 with further sub-models. For example, if multiple users report feedback expressing a need for a certain type of sensor data to be modelled by the global generative model 210, the global generative model 210 may be given an external update to include one or more sub-models that model such sensor data. Another possibility is for a sub-model already present in the global generative model 210 to divide into multiple sub-models. For example, in a Gaussian mixture model, a cluster, which may be in the form of a Gaussian distribution, may accumulate further data and evolve into two closely located but separately formed Gaussian distributions.

To illustrate how a Gaussian mixture model may expand to form more sub-models, a particular example is given where all sub-models 210-1 to 210-6 may correspond to the same type of measurement, which may also correspond to the same type of physical data. This may be position information recorded by a GPS sensor of a portable object, such as a smartwatch or smartphone. The difference in each sub-model may lie in a varying scale of change in position over a specified time interval. If a user has used many different forms of transportation, then each form of transportation may form a separate sub-model. This may include walking (210-1), biking (210-2), a road vehicle (210-3), a subway (210-4), a ferry (210-5), and an airplane (210-6).

If position information recorded by means of a GPS sensor each time the user A was moving or transported, it may be accurately modelled by a Gaussian mixture model. The more times the user A uses the form of transportation, the more datapoints may be recorded, and the more the cluster may be accurately modelled. Six clusters may be depicted, each cluster corresponding to a sub-model of transport as described above. If a new mode of transportation is taken by the user A and the speed of the user is significantly different from all six sub-models, for instance, with a transport by helicopter, then this would be likely to form a new cluster. Also, if two different versions of a particular sub-model begin to appear, this may also a lead to a division of a sub-model into two separate sub-models. For example, the road vehicle sub-model 210-3 may eventually divide into separate sub-models related to different types of road vehicles. For example, one sub-model may be related to a bus, while another model may be related to a personal car. It may be that only through multiple exchanges with multiple users that this difference becomes clear over time within the dataset to form two different sub-models. Such an evolution of the global generative model 210 in a modular form may enable the collaborative learning system 300 to improve its ability to provide synthetic sensor data 310 that accurately reflects the authentic sensor data 110 of the user A.

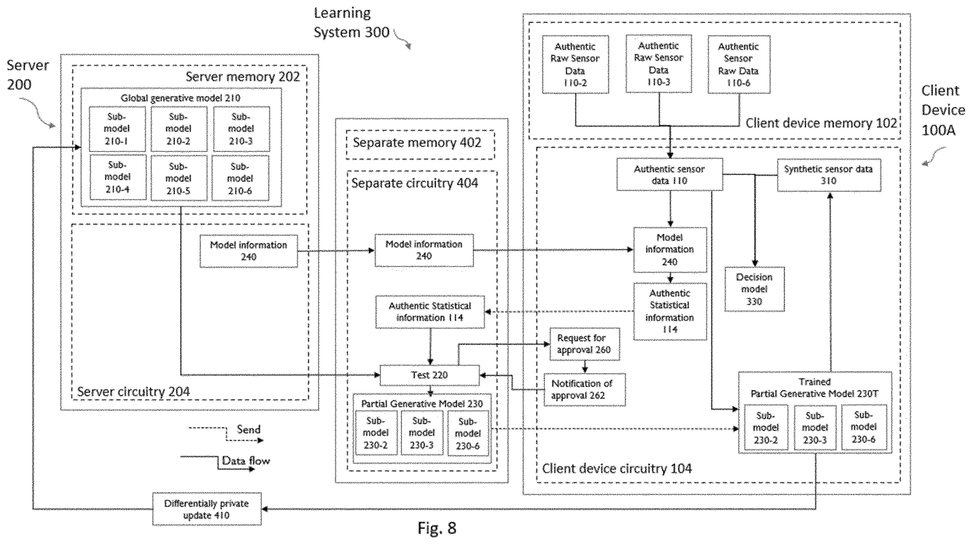

FIG. 8 shows a block diagram of a further embodiment of the collaborative learning system 300 including features related to enhanced privacy based on the present disclosure. One privacy feature relates to a separate computing environment 400. The server 200 may be communicatively connectable to the separate computing environment 400 comprising a separate memory 402 and a separate circuitry 404 for relaying information between the server 200 and the client device 100A. The server circuitry 204 may be configured to connect to the separate computing environment 400 and transmit to the separate computing environment 400, on the condition that it is exclusively connected with the client device 100A and the server 200, an updated version of one or more global generative sub-models and model information 240 related to the global generative model 210 and how to derive a user-specific partial generative model 230. Alternatively, the one or more global generative sub-models and the model information 240 may be stored in the separate memory 402 and periodically updated from the server 200 independently of a connection to the client device 100A. The information transmitted to the separate computing environment 400 may include model information 240 on the plurality of statistical parameters the global generative model 210 is able to model and how to apply the test 220 to one or more of the global generative sub-models 210-1 to 210-6 whether it should be selected to derive the user-specific partial generative model 230. In this way, information related to the authentic sensor data 110 and information related to the derived partial generative model 230 may be spared from being transmitted to the server 200. As such, the user-specific scope of sub-models may be given a higher level of privacy.

In other embodiments related to the privacy options explained above, the server 200 may have limited communication with the client device 100A that does not include a revealing of information related to the authentic sensor data 110. For example, the server 200 may still directly transmit the model information 240 to the client device 100A.

Another privacy feature relates to a request for user approval 260. The server circuitry 204 may be configured to, after receiving the authentic statistical information 114 from the client device 100A, send a list of one or more global generative sub-models 210-1 to 210-6 selected to derive the user-specific partial generative model 230 to the client device 100A with a request 260 for an approval by the user. In the case of FIGS. 2 and 4, the sub-models that were selected were sub-models 210-2, 210-3, and 210-6 of the global generative model 210, which became sub-models 230-2, 230-3, and 230-6 of the partial generative model 230. The user A may receive the list of the partial generative sub-models 210-2, 210-3, and 210-6 and optionally information explaining further details related to each sub-model. In the case of approval by the user, the client device 100A may be configured to send a notification 262 that the request 260 was approved and the server 200 may be configured to derive the user-specific partial generative model 230 based on the list upon receiving the notification 262 and to send the partial generative model 230 to the client device 100A.

Such a feature including the request 260 for user approval is an added layer of security for the user to ensure that all data or metadata desired to be kept private is indeed kept private. For example, if the sub-model 210-2 is able to model statistical parameters related to a heart rate and the user A wishes to not participate in any form of data exchange related to health within the collaborative learning system 300, the user may reject the request for approval 260 or modify the list by removing the sub-model 210-2 from the list. In this case, a partial generative model only including sub-models 210-3 and 210-6 may be derived and sent to the client device 100A.

The global generative model 210 may be updated by the partial generative model 230T that was trained by the authentic sensor data 110. Given adequate details in the model information 240, updates to the global generative model may be updated directly on the client device 100A for greater privacy, and then sent to the server. A differentially private update 410 may be used to keep the scope of sub-models that is specific to the user private. The differentially private update 410 may also incorporate an inclusion of datapoints to all relevant global generative sub-models without a corresponding label to reveal how the datapoints were categorized in a context of the global generative model 210.

FIG. 9 shows a block diagram of the collaborative learning system 300, shown with the server 200 communicatively connected to the first client device 100A associated with the user A and a second client device 100B associated with a user B. All features and processes of the collaborative learning system 300 shown in FIG. 2 for the first client device 100A are shown in FIG. 9. Each item associated with a first exchange of FIG. 9 between the first client device 100A and the server 200 is written with an added “A” to better distinguish them from the corresponding items associated with a subsequent second exchange of FIG. 9 between the second client device 100B and the server 200. All features and processes shown in FIG. 2 are also shown for the second exchange occurring between the second client device 100B and the server 200. While the exchanges each taken alone do not have any different features or processes of the collaborative learning system 300 shown in FIG. 2, FIG. 9 is meant to convey how the second exchange between the second client device 100B and the server 200 may be affected by the first exchange involving the first client device 100A.

The second client device 100B comprises second user-specific authentic sensor data 110B. The second client device 100B may be configured to receive model information 240B corresponding to the updated capabilities of the global generative model 210 to model a possibly expanded plurality of statistical parameters. In response, the second client device 100B may be configured to calculate second user-specific authentic statistical information 114B and send the second user-specific authentic statistical information 114B to the server 200. The server 200 may be configured to derive a second user-specific partial generative model 230B from the global generative model 210 based on the received second user-specific authentic statistical information 114B and to send the second user-specific partial generative model 230B to the second client device 100B. The second user-specific partial generative model 230B may be adjusted to generate second user-specific synthetic sensor data 310B which may be used by the second client device 100B to learn a second decision model 330B locally.

Since the second exchange between the second client device 100B and the server 200 may occur subsequent to the first exchange between the first client device 100A and the server 200, the second user-specific partial generative model 230B, and thus the second user-specific synthetic sensor data 310B and the second decision model 330B of the second client device 100B may be affected by the first user-specific authentic sensor data 110A of the first client device 100A. Accordingly, weights of the second decision model 330B for the second client device 100B may be trained with a dependency of the first decision model 330A for the first client device if there is a common sub-model derived from the global generative model 210 between the two users.

After the first exchange between the first client device 100A and the server 200, one or more sub-models 210-1 to 210-6 of the the global generative model 210 may be updated based on the first authentic sensor data 110A, as shown in FIG. 4. In this case, the server circuitry 204 may be configured to derive the second user-specific partial generative model 230B based on the first authentic sensor data 110A. In particular, if one of the global generative sub-models 210-1 to 210-6 that has been updated based on the first authentic statistical properties 110A is also selected to derive the second partial generative model 230B, then that selected sub-model will comprise one or more updated values that have been updated based on the first authentic statistical properties 110A.

For example in FIG. 9, the first partial generative model 230A comprises sub-models 230-2A, 230-3A, and 230-6A, while the second partial generative model 230B comprises sub-models 230-2B, 230-4B, and 230-5B. The sub-models chosen to derive the first partial generative model 230A in the first exchange are shown to be 210-2, 210-3, and 210-6, while the sub-models chosen to derive the second partial generative model 230B are shown to be 210-2, 210-4, and 210-5. The only common sub-model to both partial generative models 230A; 230B in this case is the global generative sub-model 210-2. Thus, only the partial generative sub-model 230-2B in this case may be affected by the first authentic sensor data 110A, while partial generative sub-models 230-4B and 230-5B may remain independent of the first authentic sensor data 110A.

The modular form of the global generative model 210 as presented is a form that enables a greater efficiency of computation by the global generative model 210. By limiting the number of sub-models sent to each user to only the relevant sub-models based on the authentic statistical information 114 and by only updating those sub-models, the amount of required data processing for both the server 200 and the respective client device 100A; 100B may be greatly reduced and may enable a larger number of users to participate in the collaborative learning system 300. The modular form also results in the user A sharing statistical information 114 related to the authentic sensor data 110 only to other users who will find it relevant, eliminating an unnecessary sharing of such information to a large portion of users.

FIG. 10 shows a block diagram of a frictionless authentication (FA) procedure 600 to calculate a calibrated FA score 642 based on the authentic sensor data 110 of the client device 100A. In a further embodiment of the present disclosure, the decision model 330 of the client device 100A may be a discriminative machine learning model configured to authenticate, or detect an impersonation, in a frictionless manner, without requiring user intervention. The decision model 330 may have been trained by the authentic sensor data 110 and the generated synthetic sensor data 310, as depicted in FIGS. 2, 4, 5, 7, 8, and 9. The training may have included methods of comparing the authentic sensor data 110 associated with the user A to the synthetic sensor data 310 simulating one or more hypothetical users and distinguishing the user A from the hypothetical users. A similar emerging field relates to continuous authentication, in which a computer system is continuously authenticating the user A by monitoring the user behavior during a user session. The more the user A has used a software applying continuous authentication, the more authentic user data 110 can be contributed to the learning of the decision model 330 and the more customized the decision model 330 can be towards the actual behavior of the user A.

Based on an input of authentic sensor data 110 accumulated over time and synthetic sensor data 310 with statistical properties corresponding to the authentic sensor data 110, the decision model 330 may be a discriminative machine learning model that is configured to frictionlessly and/or continuously generate a FA score 642 of the user A. For example, the user A may have the decision model 330 in a personal device, such as a personal mobile phone, a personal computer, or a personal vehicle, and the identity of user A may be authenticated in a frictionless manner each time the personal device is used. If any data collected by the personal device is determined to be significantly different from a well-established pattern of the user, the personal device may be configured to shut down or prompt the user for a password or PIN to provide an extra layer of security.

The decision model 330 may be trained from the authentic sensor data 110, but decision models usually need a larger pool of data beyond typical use and data collection by a single user to be effectively trained. In a first example related to frictionless authentication, the sub-models of the global generative model 210 may provide this larger pool of data by modelling physical data, biometric data and/or behavioral data of many users, each user having updated the global generative model 210 based on respective authentic sensor data 110. The authentic sensor data 110 on the client device 100A may be compared to a large pool of synthetic sensor data 310 to frictionlessly and/or continuously authenticate the user A. Data corresponding to a particular sub-model 210-1 to 210-6 on the client device 100A may be used in a frictionless authentication of a modular form analogous to a modular form of the global generative model 210. A sub-score may be calculated corresponding to a specific sub-model, and each sub-score may contribute to an overall FA score 642.

In a particular example of frictionless authentication, the global generative sub-models 210-1 to 210-6 may model different forms of biometric or behavioral data, which may have been processed from a form of physical data on the respective client device 100A. A great variety of biometric and/or behavioral data types as part of multiple sub-models may be useful to authenticate a user. For example, if one sub-model shows results of an unconventional behavior of the user A while all other sub-models show results of behavior that is fully normal for the user A, the authentication for user A may be considered successful to prevent an unreasonably high number of authentication failures. For example, the sub-models may model thermometer data related to user skin temperature measurements (210-1), accelerometer data related to user steps by feet (210-2), an optical heart rate data of the user (210-3), time distribution data related to time spent by the user using a specific software (210-4), user selection data related to likes on a social media network (210-5), and user position data by GPS measurements (210-6), among other datatypes. Many such models may be modelled by sensor data recorded by sensors on a smartwatch or smartphone. For example in FIG. 2, the client device 100A may be a smartwatch that may be capable of recording and processing accelerometer data related to the steps taken by user A (210-2), the optical heart rate of user A (210-3), and position data of user A by GPS measurements (210-6). Each of these sub-models may be recorded at separate times or during overlapping times. Each of the sub-models 210-2, 210-3, and 210-6 may be relevant in providing user A with corresponding synthetic sensor data 310 by means of a partial generative model 230 with partial generative sub-models 230-2, 230-3, and 230-6, each of which may be used as a comparison to the authentic sensor data 110 for authentication.

In an embodiment of the present disclosure, the client device 100A may comprise multiple neural networks, which may include an embedding neural network and a decision neural network. In the training procedure 600 applied to a neural network, weights of the neural network may be initialized and then updated as training proceeds. The FA procedure 600 may include training phases applied to one or more neural networks. These may include a phase of preparation 610, a phase of embedding 620, a phase of identification 630, and a phase of calibration 640, which may enable the client device 100A to a generate the calibrated FA score 642. During frictionless authentication, a portion of the authentic sensor data 110 may be tested, whether it indeed corresponds to the user A or if there has been an attempt of fraud within the client device 100A. An input to the decision model 330 trained for frictionless authentication may be a portion of the authentic sensor data 110 and a corresponding output may be a score that communicates a normal status or a fraud alert status.

The preparation phase 610 of the FA procedure 600 may include a step of applying a window function 612 to restrict the input dataset to a chosen interval. The preparation phase 610 may also include a step of filtering 614, which may complement the windowing step 612 in filtering any portions of authentic sensor data 110 determined to be outliers or irrelevant to the FA procedure 600. The filter may also include a filtering algorithm designed to optimize a Fourier Transform of input data. In step 616, a Fast Fourier Transform (FFT) may be applied to the input data, breaking down the input data into constituent sinusoids of different frequencies. The embedding and/or decision neural network may be a convolutional neural network (CNN), which may perform many computations in the form of convolutions. A convolution in a time domain may become a multiplication in a frequency domain. A FFT may convert input data into a frequency domain to perform multiplications, which may reduce processing and computation requirements. In other words, the FFT may be used to simplify a convolution in a CNN and may help to produce an output at a much faster rate in the embedding phase 620.

Embeddings within a neural network may be learned low-dimensional representations of discrete data as continuous vectors that may help the neural network operate more efficiently. They may be created within a neural network by a training of a model. Neural network embeddings may be useful because they may reduce the dimensionality of categorical variables and meaningfully represent categories in the transformed space. Such embeddings may overcome limitations of traditional encoding methods and can be used for purposes of finding nearest neighbors in a cluster model, or a Gaussian mixture model. In an embodiment of the present disclosure, the embedding neural network may have been pre-trained to create an embedding layer with fixed weights. Raw authentic sensor data from several sensors 110-2; 110-3; 110-6 may be fused and processed by the embedding neural network. The embedding layer may capture gait dimensions, which may correspond to various biometric data of a respective user, which may enable a distinguishing of the user from hypothetical users during frictionless authentication.

The embedding phase 620 of the FA procedure 600 may include batch normalization. Batch normalization may include a normalization of layer inputs by re-centering and re-scaling, which may result in a faster processing by a CNN. More specifically, a batch normalization layer may, during a training, calculate the mean and variance of the layer inputs, normalize the layer inputs using the previously calculated batch statistics, and may perform scaling and shifting to obtain the output of the layer. This may mitigate problems related to an internal covariate shift, where changes related to randomness in a distribution of inputs of each layer may affect the learning rate of the network. This may have the effect of stabilizing the learning process and greatly reducing the number of training rounds required to train the neural network. Batch normalization may also reduce the sensitivity to initial starting weights.

The embedding phase 620 may include a step 622 of batch normalization implemented on a 2D convolution layer 622 and a step 624 of batch normalization on a 1D convolution layer 624. The embedding phase 620 may also include a step 626 of applying a gated recurrent unit (GRU) dropout layer. A dropout layer may be used in a CNN to prevent overfitting in a training dataset. Overfitting describes the case of a machine learning model performing so well on the training data that it causes a negative impact in the model's performance when used on new data. In a dropout layer, a few neurons may be dropped from the neural network during the training process, which may result in a simpler form and/or reduced size of the model. The GRU is a variant of the recurrent neural network (RNN) architecture, and may use gating mechanisms to manage the flow of information between cells in a neural network. Finally, the embedding phase 620 may also include a step 628 of calculating a mean or average of an input dataset to be used as input in the identification phase 630.

The FA procedure then continues to the identification phase 630. The objective of identification phase 630 may be to train the decision model 330 to distinguish between authentic sensor data 110 and synthetic sensor data 310. The identification phase 630 may include a step 632 of two iterations of dense batch normalization (2× Dense BatchNorm). A dense layer, or densely connected neural network layer, is also referred to as a fully connected layer. It is a deeply connected layer, meaning the neurons of the layer may be connected to every neuron of its preceding layer. It may help to change the dimensionality of the output from the preceding layer so that the model can more easily define a relationship between different values of the input dataset. The identification phase 630 may also include a step 634 of soft expectation maximization (SoftMax). Soft expectation maximization, or soft clustering, is a form of clustering where an individual datapoint may belong to multiple clusters, as previously described. A procedure of soft clustering may include calculating for each observation the probability that it belongs to a given cluster. As opposed to hard expectation maximization, where each datapoint is assigned to a cluster of highest probability, SoftMax does not require assigned each datapoint to one cluster. Rather it maintains one or more probabilities for each datapoint that it is associated with a respective cluster and thus may lead to intersecting clusters.

The calibration phase 640 may include a test of externally authenticated datasets of the authentic sensor information 110 to verify that the trained decision model 330 is configured as desired. More specifically, biometric and/or behavioral data of the user A may be compared to analogous biometric and/or behavioral data of a synthetic target population of users based on the synthetic sensor data 310. If such a test revealed any false authentication or false fraud alerts, then the decision model 330 may be re-calibrated or re-trained as necessary. The calibration phase 640 may yield a probability that an input data corresponding to the authentic sensor data 110 is of the user A or not and may accept the training once the probability that the externally authenticated dataset is above a pre-defined threshold. Once trained, the decision model 330 may apply the newly trained ability to distinguish between the authentic sensor data 110 and the synthetic sensor data 310 for frictionless authentication. In other words, the decision model 330 may be a discriminative machine learning model that may be trained to distinguish the user A, corresponding to the authentic sensor data 110, from a plurality of hypothetical users, corresponding to the synthetic sensor data 310.

Frictionless authentication may be useful in a variety of further scenarios. In a first scenario, the user A may want to benefit from the FA procedure 600 to unlock a personal vehicle while approaching it. For example, an authentication may be performed by image recognition with data input from an image sensor. User A may then enter the vehicle without having to use a key or electronic device to unlock the vehicle. In a second scenario, the user B may be managing a small bicycle-delivery service. The user B may subscribe to an anomaly detection service that can monitor the employees of user B, each of whom may contribute authentic sensor data 110 related to biking. The anomaly detection service may use the FA procedure 600 to ensure that each employee is following an efficient route to perform the delivery and that no bicycle is being used by a non-employee. Such an example may be based on GPS position information of each employee or other sensors placed on each bicycle. In such examples, the global generative model 210 may form one or more sub-models specifically oriented toward unlocking a vehicle or the bicycle-delivery service.

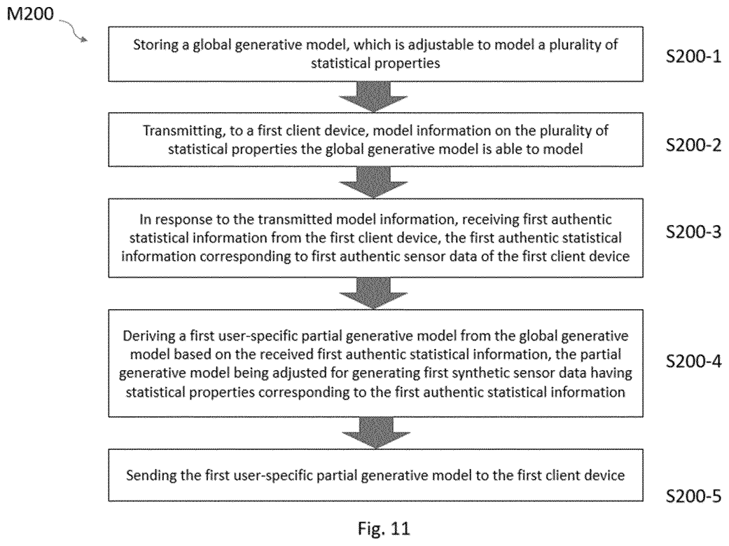

FIG. 11 summarizes the proposed concept by illustrating a flowchart of a method M200 for a server 200 that is communicatively connectable to a client device 100A for a collaborative learning system 300 based on the present disclosure.

Method M200 includes a step S200-1 of storing, at the server 200, a global generative model 210, which is adjustable to model a plurality of statistical parameters. Method M200 further includes a step S200-2 of transmitting, from the server 200 to the client device 100A, model information 240 on the plurality of statistical parameters the global generative model 210 is able to model, and a step of S200-3 of, in response to the transmitted model information 240, receiving user-specific authentical statistical information 114 from the client device 100A, the user-specific authentical statistical information 114 corresponding to user-specific authentic sensor data 110 of the client device 100A. Method M200 also includes a step S200-4 of deriving, at the server 200, a user-specific partial generative model 230 from a global generative model 210 based on the received authentic user-specific statistical information 114, the user-specific partial generative model 230 being adjusted for generating user-specific synthetic sensor data 310 having statistical properties 310 corresponding to the user-specific authentic statistical information 114, and a step S200-5 of sending the user-specific partial generative model 230 to the client device 100A.

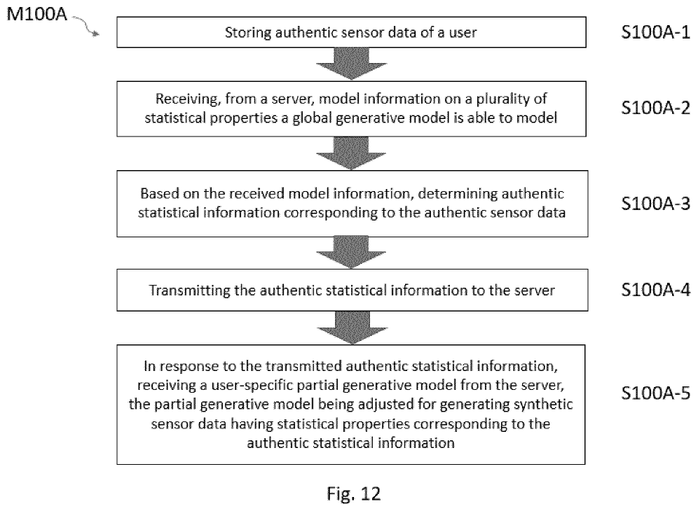

FIG. 12 summarizes the proposed concept by illustrating a flowchart of a client device method M100A for a client device 100A that is communicatively connectable to a server 200 for a collaborative learning system 300 based on the present disclosure.

Method M100A includes a step S100A-1 of storing, at the client device 100A, user-specific authentic sensor data 110 of a user A. Method M100A further includes a step S100A-2 of receiving, from the server 200, model information 240 on a plurality of statistical parameters a global generative model 210 is able to model, and a step S100A-3 of, based on the received model information 240, determining user-specific authentic statistical information 114 corresponding to the user-specific authentic sensor data 110. Method M100A further includes a step S100A-4 of transmitting the user-specific authentic statistical information 114 to the server 200, and a step S100A-5 of, in response to the transmitted user-specific statistical information 114, receiving a user-specific partial generative model 230 from the server 200 that is adjusted for generating user-specific synthetic sensor data 310 having statistical properties corresponding to the user-specific authentic statistical information 114.

Note that the present technology can also be configured as described below.

Example 1 is a server for a collaborative learning system, wherein the server is communicatively connectable to at least a first client device associated with a first user, the server comprising a memory configured to store a global generative model, which is adjustable to model a plurality of statistical parameters, and a circuitry configured to transmit, to the first client device, model information on the plurality of statistical parameters the global generative model is able to model, in response to the transmitted model information, receive first authentic statistical information from the first client device, the first authentic statistical information corresponding to first authentic sensor data of the first client device, derive a first user-specific partial generative model from the global generative model based on the received first authentic statistical information, the first user-specific partial generative model being adjusted for generating first synthetic sensor data having statistical properties corresponding to the first authentic statistical information, and send the first user-specific partial generative model to the first client device.

In Example 2, the global generative model of the server of Example 1 comprises a plurality of global generative sub-models, each global generative sub-model being adjustable to model a different subset of the plurality of statistical parameters, wherein the server circuitry of Example 1 is configured to, in response to the transmitted model information, receive the first authentic statistical information from the first client device, the first authentic statistical information comprising statistical properties related to a subset of the plurality of statistical parameters, based on the received first authentic statistical information, apply a first test to one or more of the global generative sub-models whether it should be selected to derive the first user-specific partial generative model, derive the first user-specific partial generative model based on at least one selected global generative sub-model, and send the first user specific partial generative model to the first client device.

In Example 3, the server circuitry of Example 2 is configured to update the one or more global generative sub-models of the global generative model that were selected to derive the first user-specific partial generative model based on the first authentic sensor data, wherein global generative sub-models of the global generative model that were not selected to derive the first user-specific partial generative model remain independent of the first authentic sensor data.

In Example 4, the server circuitry of Example 2 or 3 is configured to transmit, to the first client device, second-round model information on the plurality of statistical parameters the global generative model is able to model, in response to the transmitted second-round model information, receive second-round authentic statistical information from the first client device, the second-round authentic statistical information corresponding to a second measurement iteration of the first authentic sensor data of the first client device, based on the received second-round authentic statistical information, apply a second-round test to one or more of the global generative sub-models whether it should be selected to derive a calibrated user-specific partial generative model, derive the calibrated user-specific partial generative model based on at least one selected global generative sub-model, and send the calibrated user-specific partial generative model to the first client device.

In Example 5, the server circuitry of any one of Examples 2 to 4 is configured to, after receiving the first authentic statistical information from the first client device, send a list of one or more global generative sub-models selected to derive the first user-specific partial generative model to the first client device with a request for an approval by the first user, and in the case of approval, derive the first user-specific partial generative model based on the list and send the first user-specific partial generative model to the first client device.

In Example 6, the server of any one of Examples 2 to 5 is communicatively connectable to a separate computing environment comprising a separate memory and a separate circuitry for relaying information between the at least first client device and the server, wherein the server circuitry is configured to connect to the separate computing environment and transmit to the separate computing environment, on the condition that the separate computing environment is exclusively connected with the first client device and the server, an updated version of one or more global generative sub-models and instructions, the instructions including sending model information on the plurality of statistical parameters the global generative model is able to model to the first client device, receiving authentic statistical information from the first client device, applying the first test to one or more of the global generative sub-models sent from the server whether it should be selected to derive the first user-specific partial generative model, deriving the first user-specific partial generative model based on at least one selected global generative sub-model, and sending the first user-specific partial generative model to the client device.

In Example 7, the server of any one of the previous Examples is communicatively connectable to a second client device associated with a second user, wherein the circuitry is configured to transmit, to the second client device, model information on the plurality of statistical parameters the global generative model is able to model, in response to the transmitted model information, receive second authentic statistical information from the second client device, the second authentic statistical information corresponding to second authentic sensor data of the second client device, derive a second user-specific partial generative model from the global generative model based on the received second authentic statistical information, the second user-specific partial generative model being adjusted for generating second synthetic sensor data having statistical properties corresponding to the second authentic statistical information, and send the second user-specific partial generative model to the second client device.

In Example 8, the server of Example 7 is configured to receive the first authentic statistical information from the first client device, derive the first user-specific partial generative model from the global generative model based on the received first authentic statistical information, send the first user-specific partial generative model to the first client device, and receive from the first client device a first update of the global generative model based on a training of the first partial generative model by the first authentic sensor data, and to subsequently receive the second authentic statistical information from the second client device, derive the second user-specific partial generative model from the global generative model based on the received second authentic statistical information and the first update of the global generative model, send the second user-specific partial generative model to the second client device and receive from the second client device a second update of the global generative model based on a training of the second partial generative model by the second authentic sensor data.

In Example 9, the server circuitry of Example 7 or 8 is configured to, in response to the transmitted model information, receive the second authentic statistical information from the second client device, the second authentic statistical information comprising statistical properties related to a second subset of the plurality of statistical parameters, based on the received second authentic statistical information, apply a second test to one or more of the global generative sub-models whether it should be selected to derive the second user-specific partial generative model, derive the second user-specific partial generative model based on at least one selected global generative sub-model, and send the second user-specific partial generative model to the second client device.

In Example 10, the global generative model of the server of Example 9 comprises one or more global generative sub-models updated based on the first authentic statistical sensor data, wherein the circuitry of Example 9 is configured to derive the second partial generative model based on the first authentic sensor data if one of the global generative sub-models updated based on the first authentic sensor data is selected to derive the second partial generative model.

In Example 11, the global generative model of the server of Example 9 comprises one or more global generative sub-models updated based on the first authentic sensor data, wherein the circuitry of Example 9 is configured to derive the second partial generative model independently of the first authentic sensor data if none of the global generative sub-models updated based on the first authentic sensor data is selected to derive the second partial generative model.

Example 12 is a client device for a collaborative learning system that is associated with a user and communicatively connectable to a server, the client device comprising a memory storing authentic sensor data of the user and a circuitry configured to receive, from the server, model information on a plurality of statistical parameters a global generative model is adjustable to model, based on the received model information, determine authentic statistical information corresponding to the authentic sensor data, transmit the authentic statistical information to the server, and in response to the transmitted authentic statistical information, receive a user-specific partial generative model from the server, the partial generative model being adjusted for generating synthetic sensor data having statistical properties corresponding to the authentic statistical information.

In Example 13, the client device circuitry of Example 12 is configured to generate the synthetic sensor data based on the partial generative model and learn a decision model based on the synthetic sensor data and the authentic sensor data.

In Example 14, the decision model of the client device of Example 13 is configured to output an authentication score of the user based on the authentic sensor data and the synthetic sensor data.

Example 15 is a collaborative learning system comprising a server, the server comprising a server memory storing a global generative model which is adjustable to model a plurality of statistical parameters, and at least a first client device associated with a first user, the first client device being communicatively coupled to the server and comprising a respective client device memory storing first authentic sensor data of the first user, wherein the first client device comprises a respective client device circuitry configured to receive, from the server, model information on the plurality of statistical parameters the global generative model is able to model, and based on the received model information, determine first authentic statistical information corresponding to the first authentic sensor data, and send the first authentic statistical information to the server, wherein the server comprises a server circuitry configured to transmit, to the first client device, model information on the plurality of statistical parameters the global generative model is able to model, and in response to the transmitted model information, receive the first authentic statistical information from the first client device, derive a first user-specific partial generative model from the global generative model based on the received first authentic statistical information, the first partial generative model being adjusted for generating first synthetic sensor data having statistical properties corresponding to the first authentic statistical information, and to send the first partial generative model to the first client device.

In Example 16, the first client device circuitry of the collaborative learning system of Example 15 is configured to generate the first synthetic sensor data of the first user based on the first partial generative model and learn a first decision model based on the first synthetic sensor data and the first authentic sensor data.

In Example 17, the collaborative learning system of Example 15 or 16 further comprises a second client device associated with a second user, the second client device being communicatively coupled to the server, and comprising a respective client device memory storing second authentic sensor data of the second user, wherein the second client device comprises a respective client device circuitry configured to receive, from the server, model information on the plurality of statistical parameters the global generative model is able to model, based on the received model information, determine second authentic statistical information corresponding to the second authentic sensor data; and send the second authentic statistical information to the server, wherein the server circuitry is configured to transmit, to the second client device, information on the plurality of statistical parameters the global generative model is able to model, in response to the transmitted model information, receive the second authentic statistical information from the second client device, derive a second user-specific partial generative model from the global generative model based on the received second authentic statistical information, the second partial generative model being adjusted for generating second synthetic sensor data having statistical properties corresponding to the second authentic statistical information, and send the second partial generative model to the second client device.

In Example 18, the second client device circuitry of the collaborative learning system of Example 17 is configured to generate the second synthetic sensor data of the second user based on the second partial generative model and learn a second decision model based on the second synthetic sensor data and the second authentic sensor data.

Example 19 is a method for a server of a collaborative learning system comprising storing a global generative model, which is adjustable to model a plurality of statistical parameters, transmitting, to a first client device, model information on the plurality of statistical parameters the global generative model is able to model, in response to the transmitted model information, receiving first authentic statistical information from the first client device, the first authentic statistical information corresponding to first authentic sensor data of the first client device, deriving a first user-specific partial generative model from the global generative model based on the received first authentic statistical information, the first user-specific partial generative model being adjusted for generating first synthetic sensor data having statistical properties corresponding to the first authentic statistical information, and sending the first user-specific partial generative model to the first client device.

Example 20 is a method for a client device of a collaborative learning system, the client device method comprising storing authentic sensor data of a user, receiving, from a server, model information on a plurality of statistical parameters a global generative model is able to model, based on the received model information, determining authentic statistical information corresponding to the authentic sensor data, transmitting the authentic statistical information to the server; and in response to the transmitted authentic statistical information, receiving a user-specific partial generative model from the server, the partial generative model being adjusted for generating synthetic sensor data having statistical properties corresponding to the authentic statistical information.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include local computer devices (e.g. personal computer, laptop, tablet computer or mobile phone) with one or more processors and one or more storage devices or may be a distributed computer system (e.g. a cloud computing system with one or more processors and one or more storage devices distributed at various locations, for example, at a local client and/or one or more remote server farms and/or data centers). The computer system may comprise any circuit or combination of circuits. In one embodiment, the computer system may include one or more processors which can be of any type. As used herein, processor may mean any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, a field programmable gate array (FPGA), for example, of a microscope or a microscope component (e.g. camera) or any other type of processor or processing circuit. Other types of circuits that maybe included in the computer system may be a custom circuit, an application-specific integrated circuit (ASIC), or the like, such as, for example, one or more circuits (such as a communication circuit) for use in wireless devices like mobile telephones, tablet computers, laptop computers, two-way radios, and similar electronic systems. The computer system may include one or more storage devices, which may include one or more memory elements suitable to the particular application, such as a main memory in the form of random access memory (RAM), one or more hard drives, and/or one or more drives that handle removable media such as compact disks (CD), flash memory cards, digital video disk (DVD), and the like. The computer system may also include a display device, one or more speakers, and a keyboard and/or controller, which can include a mouse, trackball, touch screen, voice-recognition device, or any other device that permits a system user to input information into and receive information from the computer system. Some or all of the method steps may be executed by (or using) a hardware apparatus, like for example, a processor, a microprocessor, a programmable computer or an electronic circuit. In some embodiments, some one or more of the most important method steps may be executed by such an apparatus. Depending on certain implementation requirements, embodiments of the invention can be implemented in hardware or in software. The implementation can be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may, for example, be stored on a machine-readable carrier.

Other embodiments comprise the computer program for performing one of the methods described herein, stored on a machine-readable carrier.

In other words, an embodiment of the present invention is, therefore, a computer program having a program code for performing one of the methods described herein, when the computer program runs on a computer.

A further embodiment of the present invention is, therefore, a storage medium (or a data carrier, or a computer-readable medium) comprising, stored thereon, the computer program for performing one of the methods described herein when it is performed by a processor. The data carrier, the digital storage medium or the recorded medium are typically tangible and/or non-transitionary. A further embodiment of the present invention is an apparatus as described herein comprising a processor and the storage medium.

A further embodiment of the invention is, therefore, a data stream or a sequence of signals representing the computer program for performing one of the methods described herein. The data stream or the sequence of signals may, for example, be configured to be transferred via data communication connection, for example, via the internet.

A further embodiment comprises a processing means, for example, a computer or a programmable logic device, configured to, or adapted to, perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example, a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

Embodiments may be based on using a machine learning model or machine learning algorithm. Machine learning may refer to algorithms and statistical models that computer systems may use to perform a specific task without using explicit instructions, instead relying on models and inference. For example, in machine learning, instead of a rule-based transformation of data, a transformation of data may be used, that is inferred from an analysis of historical and/or training data. For example, the content of images may be analyzed using a machine learning model or using a machine learning algorithm. In order for the machine learning model to analyze the content of an image, the machine learning model may be trained using training images as input and training content information as output. By training the machine learning model with a large number of training images and/or training sequences (e.g. words or sentences) and associated training content information (e.g. labels or annotations), the machine learning model “learns” to recognize the content of the images, so the content of images that are not included in the training data can be recognized using the machine learning model. The same principle may be used for other kinds of sensor data as well: By training a machine learning model using training sensor data and a desired output, the machine learning model “learns” a transformation between the sensor data and the output, which can be used to provide an output based on non-training sensor data provided to the machine learning model. The provided data (e.g. sensor data, meta data and/or image data) may be preprocessed to obtain a feature vector, which is used as input to the machine learning model.

Machine learning models may be trained using training input data. The examples specified above use a training method called “supervised learning”. In supervised learning, the machine learning model is trained using a plurality of training samples, wherein each sample may comprise a plurality of input data values, and a plurality of desired output values, i.e. each training sample is associated with a desired output value. By specifying both training samples and desired output values, the machine learning model “learns” which output value to provide based on an input sample that is similar to the samples provided during the training. Apart from supervised learning, semi-supervised learning may be used. In semi-supervised learning, some of the training samples lack a corresponding desired output value. Supervised learning may be based on a supervised learning algorithm (e.g. a classification algorithm, a regression algorithm or a similarity learning algorithm. Classification algorithms may be used when the outputs are restricted to a limited set of values (categorical variables), i.e. the input is classified to one of the limited set of values. Regression algorithms may be used when the outputs may have any numerical value (within a range). Similarity learning algorithms may be similar to both classification and regression algorithms but are based on learning from examples using a similarity function that measures how similar or related two objects are. Apart from supervised or semi-supervised learning, unsupervised learning may be used to train the machine learning model. In unsupervised learning, (only) input data might be supplied and an unsupervised learning algorithm may be used to find structure in the input data (e.g. by grouping or clustering the input data, finding commonalities in the data). Clustering is the assignment of input data comprising a plurality of input values into subsets (clusters) so that input values within the same cluster are similar according to one or more (pre-defined) similarity criteria, while being dissimilar to input values that are included in other clusters.

Reinforcement learning is a third group of machine learning algorithms. In other words, reinforcement learning may be used to train the machine learning model. In reinforcement learning, one or more software actors (called “software agents”) are trained to take actions in an environment. Based on the taken actions, a reward is calculated. Reinforcement learning is based on training the one or more software agents to choose the actions such, that the cumulative reward is increased, leading to software agents that become better at the task they are given (as evidenced by increasing rewards).

Furthermore, some techniques may be applied to some of the machine learning algorithms. For example, feature learning may be used. In other words, the machine learning model may at least partially be trained using feature learning, and/or the machine learning algorithm may comprise a feature learning component. Feature learning algorithms, which may be called representation learning algorithms, may preserve the information in their input but also transform it in a way that makes it useful, often as a pre-processing step before performing classification or predictions. Feature learning may be based on principal components analysis or cluster analysis, for example.

In some examples, anomaly detection (i.e. outlier detection) may be used, which is aimed at providing an identification of input values that raise suspicions by differing significantly from the majority of input or training data. In other words, the machine learning model may at least partially be trained using anomaly detection, and/or the machine learning algorithm may comprise an anomaly detection component.

In some examples, the machine learning algorithm may use a decision tree as a predictive model. In other words, the machine learning model may be based on a decision tree. In a decision tree, observations about an item (e.g. a set of input values) may be represented by the branches of the decision tree, and an output value corresponding to the item may be represented by the leaves of the decision tree. Decision trees may support both discrete values and continuous values as output values. If discrete values are used, the decision tree may be denoted a classification tree, if continuous values are used, the decision tree may be denoted a regression tree.

Association rules are a further technique that may be used in machine learning algorithms. In other words, the machine learning model may be based on one or more association rules. Association rules are created by identifying relationships between variables in large amounts of data. The machine learning algorithm may identify and/or utilize one or more relational rules that represent the knowledge that is derived from the data. The rules may e.g. be used to store, manipulate or apply the knowledge.

Machine learning algorithms are usually based on a machine learning model. In other words, the term “machine learning algorithm” may denote a set of instructions that may be used to create, train or use a machine learning model. The term “machine learning model” may denote a data structure and/or set of rules that represents the learned knowledge (e.g. based on the training performed by the machine learning algorithm). In embodiments, the usage of a machine learning algorithm may imply the usage of an underlying machine learning model (or of a plurality of underlying machine learning models). The usage of a machine learning model may imply that the machine learning model and/or the data structure/set of rules that is the machine learning model is trained by a machine learning algorithm.

For example, the machine learning model may be an artificial neural network (ANN). ANNs are systems that are inspired by biological neural networks, such as can be found in a retina or a brain. ANNs comprise a plurality of interconnected nodes and a plurality of connections, so-called edges, between the nodes. There are usually three types of nodes, input nodes that receiving input values, hidden nodes that are (only) connected to other nodes, and output nodes that provide output values. Each node may represent an artificial neuron. Each edge may transmit information, from one node to another. The output of a node may be defined as a (non-linear) function of its inputs (e.g. of the sum of its inputs). The inputs of a node may be used in the function based on a “weight” of the edge or of the node that provides the input. The weight of nodes and/or of edges may be adjusted in the learning process. In other words, the training of an artificial neural network may comprise adjusting the weights of the nodes and/or edges of the artificial neural network, i.e. to achieve a desired output for a given input.

Alternatively, the machine learning model may be a support vector machine, a random forest model or a gradient boosting model. Support vector machines (i.e. support vector networks) are supervised learning models with associated learning algorithms that may be used to analyze data (e.g. in classification or regression analysis). Support vector machines may be trained by providing an input with a plurality of training input values that belong to one of two categories. The support vector machine may be trained to assign a new input value to one of the two categories. Alternatively, the machine learning model may be a Bayesian network, which is a probabilistic directed acyclic graphical model. A Bayesian network may represent a set of random variables and their conditional dependencies using a directed acyclic graph.

Alternatively, the machine learning model may be based on a genetic algorithm, which is a search algorithm and heuristic technique that mimics the process of natural selection.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

1. A server for a collaborative learning system, wherein the server is communicatively connectable to at least a first client device associated with a first user, the server comprising:
a memory configured to store a global generative model, which is adjustable to model a plurality of statistical parameters; and
a circuitry configured to:
transmit, to the first client device, model information on the plurality of statistical parameters the global generative model is able to model;
in response to the transmitted model information, receive first authentic statistical information from the first client device, the first authentic statistical information corresponding to first authentic sensor data of the first client device;
derive a first user-specific partial generative model from the global generative model based on the received first authentic statistical information, the first user-specific partial generative model being adjusted for generating first synthetic sensor data having statistical properties corresponding to the first authentic statistical information; and
send the first user-specific partial generative model to the first client device.

2. The server of claim 1, wherein
the global generative model comprises a plurality of global generative sub-models, each global generative sub-model being adjustable to model a different subset of the plurality of statistical parameters;
wherein the circuitry is configured to:
in response to the transmitted model information, receive the first authentic statistical information from the first client device, the first authentic statistical information comprising statistical properties related to a subset of the plurality of statistical parameters;
based on the received first authentic statistical information, apply a first test to one or more of the global generative sub-models whether it should be selected to derive the first user-specific partial generative model;
derive the first user-specific partial generative model based on at least one selected global generative sub-model; and
send the first user-specific partial generative model to the first client device.

3. The server of claim 2, wherein the circuitry is configured to
update the one or more global generative sub-models of the global generative model that were selected to derive the first user-specific partial generative model based on the first authentic sensor data; wherein global generative sub-models of the global generative model that were not selected to derive the first user-specific partial generative model remain independent of the first authentic sensor data.

4. The server of claim 2, wherein the circuitry is configured to:
transmit, to the first client device, second-round model information on the plurality of statistical parameters the global generative model is able to model;
in response to the transmitted second-round model information, receive second-round authentic statistical information from the first client device, the second-round authentic statistical information corresponding to a second measurement iteration of the first authentic sensor data of the first client device;
based on the received second-round authentic statistical information, apply a second-round test to one or more of the global generative sub-models whether it should be selected to derive a calibrated user-specific partial generative model;
derive the calibrated user-specific partial generative model based on at least one selected global generative sub-model; and
send the calibrated user-specific partial generative model to the first client device.

5. The server of claim 2, wherein the circuitry is configured to:
after receiving the first authentic statistical information from the first client device, send a list of one or more global generative sub-models selected to derive the first user-specific partial generative model to the first client device with a request for an approval by the first user, and in the case of approval;
derive the first user-specific partial generative model based on the list; and
send the first user-specific partial generative model to the first client device.

6. The server of claim 2,
wherein the server is communicatively connectable to a separate computing environment comprising a separate memory and a separate circuitry for relaying information between the at least first client device and the server,
wherein the server circuitry is configured to:
connect to the separate computing environment;
transmit to the separate computing environment, on the condition that the separate computing environment is exclusively connected with the first client device and the server, an updated version of one or more global generative sub-models and instructions, the instructions including sending model information on the plurality of statistical parameters the global generative model is able to model to the first client device, receiving authentic statistical information from the first client device, applying the first test to one or more of the global generative sub-models sent from the server whether it should be selected to derive the first user-specific partial generative model, deriving the first user-specific partial generative model based on at least one selected global generative sub-model, and sending the first user-specific partial generative model to the client device.

7. The server of claim 1,
wherein the server is communicatively connectable to a second client device associated with a second user,
wherein the circuitry is configured to:
transmit, to the second client device, model information on the plurality of statistical parameters the global generative model is able to model;
in response to the transmitted model information, receive second authentic statistical information from the second client device, the second authentic statistical information corresponding to second authentic sensor data of the second client device;
derive a second user-specific partial generative model from the global generative model based on the received second authentic statistical information, the second user-specific partial generative model being adjusted for generating second synthetic sensor data having statistical properties corresponding to the second authentic statistical information; and
send the second user-specific partial generative model to the second client device.

8. The server of claim 7, wherein the circuitry is configured to:
receive the first authentic statistical information from the first client device;
derive the first user-specific partial generative model from the global generative model based on the received first authentic statistical information;
send the first user-specific partial generative model to the first client device; and
receive, from the first client device, a first update of the global generative model based on a training of the first partial generative model by the first authentic sensor data; and to subsequently
receive the second authentic statistical information from the second client device;
derive the second user-specific partial generative model from the global generative model based on the received second authentic statistical information and the first update of the global generative model;
send the second user-specific partial generative model to the second client device; and
receive, from the second client device, a second update of the global generative model based on a training of the second partial generative model by the second authentic sensor data.

9. The server of claim 7, wherein the circuitry is configured to:
in response to the transmitted model information, receive the second authentic statistical information from the second client device, the second authentic statistical information comprising statistical properties related to a second subset of the plurality of statistical parameters;
based on the received second authentic statistical information, apply a second test to one or more of the global generative sub-models whether it should be selected to derive the second user-specific partial generative model;
derive the second user-specific partial generative model based on at least one selected global generative sub-model; and
send the second user-specific partial generative model to the second client device.

10. The server of claim 9, wherein the global generative model comprises one or more global generative sub-models updated based on the first authentic sensor data,
wherein the circuitry is configured to:
derive the second partial generative model based on the first authentic sensor data if one of the global generative sub-models updated based on the first authentic sensor data is selected to derive the second partial generative model.

11. The server of claim 9, wherein the global generative model comprises one or more global generative sub-models updated based on the first authentic sensor data,
wherein the circuitry is configured to:
derive the second partial generative model independently of the first authentic sensor data if none of the global generative sub-models updated based on the first authentic sensor data is selected to derive the second partial generative model.

12. A client device for a collaborative learning system, wherein the client device is associated with a user and communicatively connectable to a server, the client device comprising:
a memory storing authentic sensor data of the user; and
a circuitry configured to:
receive, from the server, model information on a plurality of statistical parameters a global generative model is adjustable to model;
based on the received model information, determine authentic statistical information corresponding to the authentic sensor data;
transmit the authentic statistical information to the server; and
in response to the transmitted authentic statistical information, receive a user-specific partial generative model from the server, the partial generative model being adjusted for generating synthetic sensor data having statistical properties corresponding to the authentic statistical information.

13. The client device of claim 12,
wherein the circuitry is configured to:
generate the synthetic sensor data based on the partial generative model; and
learn a decision model based on the synthetic sensor data and the authentic sensor data.

14. The client device of claim 13, wherein the decision model is configured to output an authentication score of the user based on the authentic sensor data and the synthetic sensor data.

15. A collaborative learning system comprising:
a server comprising a server memory storing a global generative model which is adjustable to model a plurality of statistical parameters; and
at least a first client device associated with a first user, the first client device being communicatively coupled to the server and comprising a respective client device memory storing first authentic sensor data of the first user;
wherein the first client device comprises a respective client device circuitry configured to:
receive, from the server, model information on the plurality of statistical parameters the global generative model is able to model;
based on the received model information, determine first authentic statistical information corresponding to the first authentic sensor data; and
send the first authentic statistical information to the server;
wherein the server comprises a server circuitry configured to:
transmit, to the first client device, model information on the plurality of statistical parameters the global generative model is able to model;
in response to the transmitted model information, receive the first authentic statistical information from the first client device;
derive a first user-specific partial generative model from the global generative model based on the received first authentic statistical information, the first partial generative model being adjusted for generating first synthetic sensor data having statistical properties corresponding to the first authentic statistical information; and
send the first partial generative model to the first client device.

16. The collaborative learning system of claim 15, wherein
the first client device circuitry is configured to:
generate the first synthetic sensor data of the first user based on the first partial generative model; and
learn a first decision model based on the first synthetic sensor data and the first authentic sensor data.

17. The collaborative learning system of claim 15, further comprising a second client device associated with a second user, the second client device being communicatively coupled to the server, and comprising a respective client device memory storing second authentic sensor data of the second user;
wherein the second client device comprises a respective client device circuitry configured to:
receive, from the server, model information on the plurality of statistical parameters the global generative model is able to model;
based on the received model information, determine second authentic statistical information corresponding to the second authentic sensor data; and
send the second authentic statistical information to the server;
wherein the server circuitry is configured to:
transmit, to the second client device, information on the plurality of statistical parameters the global generative model is able to model;
in response to the transmitted model information, receive the second authentic statistical information from the second client device;
derive a second user-specific partial generative model from the global generative model based on the received second authentic statistical information, the second partial generative model being adjusted for generating second synthetic sensor data having statistical properties corresponding to the second authentic statistical information; and
send the second partial generative model to the second client device.

18. The collaborative learning system of claim 17, wherein
the second client device circuitry is configured to:
generate the second synthetic sensor data of the second user based on the second partial generative model; and
learn a second decision model based on the second synthetic sensor data and the second authentic sensor data.

19. A method for a server of a collaborative learning system, the method comprising:
storing a global generative model, which is adjustable to model a plurality of statistical parameters;
transmitting, to a first client device, model information on the plurality of statistical parameters the global generative model is able to model;
in response to the transmitted model information, receiving first authentic statistical information from the first client device, the first authentic statistical information corresponding to first authentic sensor data of the first client device;
deriving a first user-specific partial generative model from the global generative model based on the received first authentic statistical information, the first user-specific partial generative model being adjusted for generating first synthetic sensor data having statistical properties corresponding to the first authentic statistical information; and
sending the first user-specific partial generative model to the first client device.

20. A method for a client device of a collaborative learning system, the method comprising:
storing authentic sensor data of a user;
receiving, from a server, model information on a plurality of statistical parameters a global generative model is able to model;
based on the received model information, determining authentic statistical information corresponding to the authentic sensor data;
transmitting the authentic statistical information to the server; and
in response to the transmitted authentic statistical information, receiving a user-specific partial generative model from the server, the partial generative model being adjusted for generating synthetic sensor data having statistical properties corresponding to the authentic statistical information.
